(19) United States
(12) Patent Application Publication
(10) Pub. No.: US 2004/0247896 A1
(43) Pub. Date: Dec. 9, 2004

(54) Organic compositions

(76) Inventors: Paul Apen, San Francisco, CA (US); Brian Bedwell, San Jose, CA (US); Nancy Iwamoto, Ramona, CA (US); Boris Korolev, San Jose, CA (US); Bo Li, San Jose, CA (US); Kreiser Lau, Sunnyvale, CA (US)

Correspondence Address: Paul A Fattibene, Fattibene & Fattibene, 2480 Post Road, Southport, CT, 06890, US

(21) Appl. No.: 10/466,650

(22) PCT Filed: Dec. 31, 2001
(86) PCT No.: PCT/US01/50182

(51) Int. Cl. B32B 25/20

(52) U.S. Cl. 428/447

(57) ABSTRACT

The present composition provides a composition comprising: (a) thermosetting component wherein the thermosetting component comprises monomer having the structure dimer having the structure or a mixture of the monomer and the dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of the R₁, R₂, R₃, R₄, R₅, and R₆ comprises at least two isomers; and (b) adhesion promoter comprising compound having at least bifunctionality wherein the bifunctionality may be the same or different and the first functionality is capable of interacting with the thermosetting component (a) and the second functionality is capable of interacting with a substrate when the composition is applied to a substrate. The present composition is particularly useful as a dielectric material in microelectronic

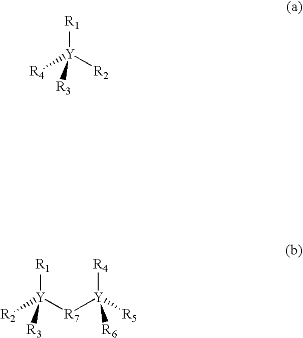

### FIELD OF THE INVENTION

The present invention relates to semiconductor devices; and in particular, to semiconductor devices having an organic low dielectric constant material and processes for the manufacture thereof.

### BACKGROUND OF THE INVENTION

In an effort to increase the performance and speed of semiconductor devices, semiconductor device manufacturers have sought to reduce the linewidth and spacing of interconnects while minimizing the transmission losses and reducing the capacitative coupling of the interconnects. One way to diminish power consumption and reduce capacitance is by decreasing the dielectric constant (also referred to as “k”) of the insulating material, or dielectric, that separates the interconnects. Insulator materials having low dielectric constants are especially desirable, because they typically allow faster signal propagation, reduce capacitance and cross talk between conductor lines, and lower voltages required to drive integrated circuits.

Since air has a dielectric constant of 1.0, a major goal is to reduce the dielectric constant of insulator materials down to a theoretical limit of 1.0, and several methods are known in the art for reducing the dielectric constant of insulating materials. These techniques include adding elements such as fluorine to the composition to reduce the dielectric constant of the bulk material. Other methods to reduce k include use of alternative dielectric material matrices.

Therefore, as interconnect linewidths decrease, concomitant decreases in the dielectric constant of the insulating material are required to achieve the improved performance and speed desired of future semiconductor devices. For example, devices having interconnect linewidths of 0.13 or 0.10 micron and below seek an insulating material having a dielectric constant (k)<3.

Currently silicon dioxide (SiO₂) and modified versions of SiO₂, such as fluorinated silicon dioxide or fluorinated silicon glass (hereinafter FSG) are used. These oxides, which have a dielectric constant ranging from about 3.5-4.0, are commonly used as the dielectric in semiconductor devices. While SiO₂ and FSG have the mechanical and thermal stability needed to withstand the thermal cycling and processing steps of semiconductor device manufacturing, materials having a lower dielectric constant are desired in the industry.

Methods used to deposit dielectric materials may be divided into two categories: spin-on deposition (hereinafter SOD) and chemical vapor deposition (hereinafter CVD). Several efforts to develop lower dielectric constant materials include altering the chemical composition (organic, inorganic, blend of organic/inorganic) or changing the dielectric matrix (porous, non-porous). Table I summarizes the development of several materials having dielectric constants ranging from 2.0 to 3.5. (PE=plasma enhanced; HDP=high-density plasma) However, the dielectric materials and matrices disclosed in the publications shown in Table 1 fail to exhibit many of the combined physical and chemical properties desirable and even necessary for effective dielectric materials, such as higher mechanical stability, high thermal stability, high glass transition temperature, high modulus or hardness, while at the same time still being able to be solvated, spun, or deposited on to a substrate, wafer, or other surface. Therefore, it may be useful to investigate other compounds and materials that may be used as dielectric materials and layers, even though these compounds or materials may not be currently contemplated as dielectric materials in their present form.

TABLE I

| | DEPOSITION | DIELECTRIC | |
|---|---|---|---|
| MATERIAL | METHOD | CONSTANT (k) | REFERENCE |
| Eluorinated silicon | PE-CVD; HDP- | 3.3-3.5 | U.S. Pat. No. 6,278,174 |
| oxide (SiOF) | CVD | | |
| Hydrogen | SOD | 2.0-2.5 | U.S. Pat. No. 4,756,977; |
| Silsesquioxane (HSQ) | | | 5,370,903; and |
| | | | 5,486,564; |
| | | | International Patent |
| | | | Publication WO 00/40637; |
| | | | E. S. Moyer et al., |
| | | | “Ultra Low k Silsesquioxane |
| | | | Based Resins”, Concepts |
| | | | and Needs for Low Dielectri$$ |
| | | | Constant <0.15 μm |
| | | | Interconnect Materials: Now |
| | | | and the Next Millennium, |
| | | | Sponsored by the American |
| | | | Chemical Society, pages |
| | | | 128-146 (Nov. 14-17, |
| | | | 1999) |
| Methyl Silsesquioxane | SOD | 2.4-2.7 | U.S. Pat. No. 6,143,855 |
| (MSQ) | | | |
| Polyorganosilicon | SOD | 2.5-2.6 | U.S. Pat. No. 6,225,238 |
| Fluorinated Amorphous | HDP-CVD | 2.3 | U.S. Pat. No. 5,900,290 |
| Carbon (a-C:F) | | | |
| Benzocyclobutene | SOD | 2.4-2.7 | U.S. Pat. No. 5,225,586 |
| (BCB) | | | |
| Polyarylene Ether (PAE) | SOD | 2.4 | U.S. Pat. No. 5,986,045; |
| | | | 5,874,516; and 5,658,994 |
| Parylene (N and F) | CVD | 2.4 | U.S. Pat. No. 5,268,202 |
| Polyphenylenes | SOD | 2.6 | U.S. Pat. No. 5,965,679 and |
| | | | 6,288,188B1; and |
| | | | Waeterloos et al., |
| | | | “Integration Feasibility of |
| | | | Porous SiLK Semiconductor |
| | | | Dielectric”, Proc. Of the |
| | | | 2001 International |
| | | | Interconnect Tech. Conf., |
| | | | pp. 253-254 (2001). |

Unfortunately, numerous organic SOD systems under development with a dielectric constant between 2.0 and 3.5 suffer from certain drawbacks in terms of mechanical and thermal properties as described above; therefore a need exists in the industry to develop improved processing and performance for dielectric films in this dielectric constant range.

Reichert and Mathias describe compounds and monomers that comprise adamantane molecules, which are in the class of cage-based molecules and are taught to be useful as diamond substitutes. (Polym, Prepr. (Am. Chem. Soc., Div. Polym. Chem.), 1993, Vol. 34 (1), pp. 495-6; Polym, Prepr. (Am. Chem. Soc., Div. Polym. Chem.), 1992, Vol. 33 (2), pp. 144-5; Chem. Mater., 1993, Vol. 5 (1), pp. 4-5; Macromolecules, 1994, Vol. 27 (24), pp. 7030-7034; Macromolecules, 1994, Vol. 27 (24), pp. 7015-7023; Polym, Prepr. (Am. Chem. Soc., Div. Polym. Chem.), 1995, Vol. 36 (1), pp. 741-742; 205ₜₕ ACS National Meeting, Conference Program, 1993, pp. 312; Macromolecules, 1994, Vol. 27 (24), pp. 7024-9; Macromolecules, 1992, Vol. 25 (9), pp. 2294-306; Macromolecules, 1991, Vol. 24 (18), pp. 5232-3; Veronica R. Reichert, PhD Dissertation, 1994, Vol. 55-06B; ACS Symp. Ser.: Step-Growth Polymers for High-Performance Materials, 1996, Vol. 624, pp. 197-207; Macromolecules, 2000, Vol. 33 (10), pp. 3855-3859; Polym, Prepr. (Am. Chem. Soc., Div. Polym. Chem.), 1999, Vol. 40 (2), pp. 620-621; Polym, Prepr. (Am. Chem. Soc., Div. Polym. Chem.), 1999, Vol. 40 (2), pp. 577-78; Macromolecules, 1997, Vol. 30 (19), pp. 5970-5975; J. Polym. Sci, Part A: Polymer Chemistry, 1997, Vol. 35 (9), pp. 1743-1751; Polym, Prepr. (Am. Chem. Soc., Div. Polym. Chem.), 1996, Vol. 37 (2), pp. 243-244; Polym, Prepr. (Am. Chem. Soc., Div. Polym. Chem.), 1996, Vol. 37 (1), pp. 551-552; J. Polym. Sci., Part A: Polymer Chemistry, 1996, Vol. 34 (3), pp. 397-402; Polym, Prepr. (Am. Chem. Soc., Div. Polym. Chem.), 1995, Vol. 36 (2), pp. 140-141; Polym, Prepr. (Am. Chem. Soc., Div. Polym. Chem.), 1992, Vol. 33 (2), pp. 146-147; J. Appl. Polym. Sci., 1998, Vol. 68 (3), pp. 475-482). The adamantane-based compounds and monomers described by Reichert and Mathias are preferably used to form polymers with adamantane molecules at the core of a thermoset. The compounds disclosed by Reichert and Mathias in their studies, however, comprise only one isomer of the adamantane-based compound by design choice. Structure A shows this symmetrical para-isomer 1,3,5,7-tetrakis[4′-(phenylethynyl)phenyl]adamantane:

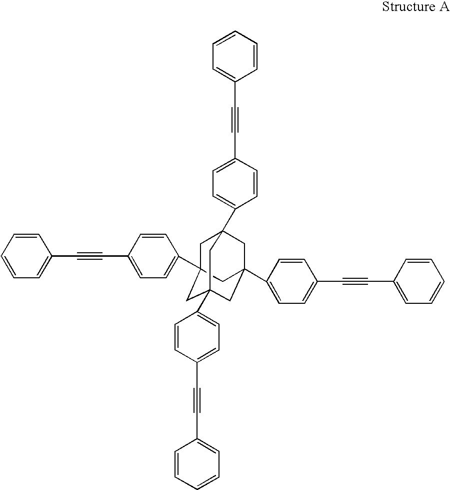

In other words, Reichert and Mathias in their individual and joint work contemplated a useful polymer comprising only one isomer form of the target adamantane-based monomer. A significant problem exists, however, when forming and processing polymers from the single isomer form (symmetrical “all-para” isomer) 1,3,5,7-tetrakis[4′-(phenylethynyl)phenyl]adamantane of the adamantane-based monomer. According to the Reichert dissertation (supra) and Macromolecules, vol. 27, (pp. 7015-7034) (supra), the symmetrical all-para isomer 1,3,5,7-tetrakis[4′-(phenylethynyl)phenyl]adamantane “was found to be soluble enough in chloroform that a ¹H NMR spectrum could be obtained. However, acquisition times were found to be impractical for obtaining a solution ¹³C NMR spectrum.” indicating that the all para isomer has low solubility. Thus, the Reichert symmetrical “all-para” isomer 1,3,5,7-tetrakis[4′-(phenylethynyl)phenyl]adamantane is insoluble in standard organic solvents and therefore, would not be useful in any application requiring solubility or solvent-based processing, such as flow coating, spin coating, or dip coating. See Comparative Example 1 below.

In our commonly assigned pending patent application PCT/US01/22204 filed Oct. 17, 2001, we discovered a composition comprising an isomeric thermosetting monomer or dimer mixture, wherein the mixture comprises at least one monomer or dimer having the structure

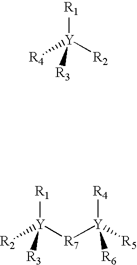

wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; and R₇ is aryl or substituted aryl. We also disclose methods for formation of these thermosetting mixtures. This novel isomeric thermosetting monomer or dimer mixture is useful as a dielectric material in microelectronics applications and soluble in many solvents such as cyclohexanone. These desirable properties make this isomeric thermosetting monomer or dimer mixture ideal for film formation at thicknesses of about 0.1 μm to about 1.0 μm.

Although various methods are known in the art to lower the dielectric constant of a material, these methods have disadvantages. Thus, there is still a need in the semiconductor industry to a) provide improved compositions and methods to lower the dielectric constant of dielectric layers; b) provide dielectric materials with improved mechanical properties, such as thermal stability, glass transition temperature (T_{g}), and hardness; and c) produce thermosetting compounds and dielectric materials that are capable of being solvated and spun-on to a wafer or layered material.

### SUMMARY OF THE INVENTION

In response to the need in the art, we have developed a composition comprising: (a) thermosetting component wherein the thermosetting component comprises monomer having the structure

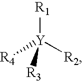

dimer having the structure

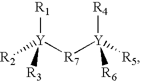

or a mixture of the monomer and the dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of the R₁, R₂, R₃, R₄, R₅, and R₆ comprises at least two isomers; and (b) adhesion promoter comprising compound having at least bifunctionality wherein the bifunctionality may be the same or different and the first functionality is capable of interacting with the thermosetting component (a) and the second functionality is capable of interacting with a substrate when the composition is applied to the substrate.

Preferably, the adhesion promoter is selected from the group consisting of:

(i) polycarbosilane of the formula (I):

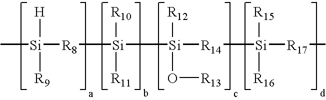

in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;

(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; and at least two of R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;

(iii) phenol-formaldehyde resins or oligomers of the formula —[R₂₂C₆H₂(OH)(R₂₃)]ⱼ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100;

(iv) glycidyl ethers;

(v) esters of unsaturated carboxylic acids containing at least one carboxylic acid group; and

(vi) vinyl cyclic oligomers or polymers wherein the cyclic group is pyridine, aromatic, or heteroaromatic.

We have also developed a method of improving adhesion to a substrate comprising the step of:

applying to the substrate, a layer of composition comprising:

(a) thermosetting component wherein the thermosetting component comprises monomer having the structure

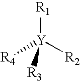

dimer having the structure

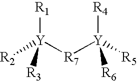

or a mixture of the monomer and the dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of R₁, R₂, R₃, R₄, R₅, and R₆ comprises at least two isomers; and

(b) adhesion promoter comprising compound having at least bifunctionality wherein the bifunctionality may be the same or different and the first functionality is capable of interacting with the thermosetting component (a) and the second functionality is capable of interacting with a substrate.

Also, we have developed a composition comprising: (a) thermosetting monomer having the structure

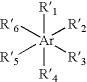

wherein Ar is aryl; R′₁, R′₂, R′₃, R′₄, R′₅, and R′₆, are independently selected from aryl, branched aryl, arylene ether, and no substitution; and wherein each of the aryl, the branched aryl, and the arylene ether has at least one ethynyl group; and (b) adhesion promoter comprising compound having at least bifunctionality wherein the bifunctionality may be the same or different and the first functionality is capable of interacting with the thermosetting monomer (a) and the second functionality is capable of Interacting with a substrate when the composition is applied to the substrate. Preferably, the adhesion promoter (b) is selected from the (i) polycarbosilanes, (ii) silanes, (iii) phenol-formaldehyde resins or oligomers, (iv) glycidyl ethers, (v) unsaturated carboxylic acid esters, or (vi) vinyl cyclic oligomers or polymers set forth above.

Also, we have developed a method of producing low dielectric constant polymer precursor or oligomer comprising the steps of:

(1) providing composition comprising: (a) thermosetting component wherein the thermosetting component comprises monomer having the structure

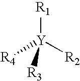

dimer having the structure

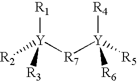

or a mixture of the monomer and the dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of the R₁, R₂, R₃, R₄, R₅, and R₆ comprises at least two isomers; and (b) adhesion promoter comprising compound having at least-bifunctionality wherein the bifunctionality may be the same or different and the first functionality is capable of interacting with the thermosetting component (a) and the second functionality is capable of interacting with a substrate when the composition is applied to the substrate; and

(2) treating the composition at a temperature from about 30° C. to about 350° C. for about 0.5 to about 60 hours thereby forming said low dielectric constant polymer precursor. Preferably, the adhesion promoter (b) is selected from the (I) polycarbosilanes, (ii) silanes, (iii) phenol-formaldehyde resins or oligomers, (iv) glycidyl ethers, (v) unsaturated carboxylic acid esters, or (vi) vinyl cyclic oligomers or polymers set forth above.

Also, we have developed a method of producing low dielectric constant polymer, comprising the steps of:

(1) providing oligomer of (a) thermosetting component wherein the thermosetting component comprises monomer having the structure

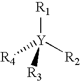

dimer having the structure

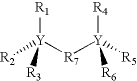

or a mixture of the monomer and the dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of the R₁, R₂, R₃, R₄, R₅, and R₆ comprises at least two isomers; and (b) adhesion promoter comprising compound having at least bifunctionality wherein the bifunctionality may be the same or different and the first functionality is capable of interacting with the thermosetting component (a) and the second functionality is capable of interacting with a substrate when the composition is applied to the substrate; and

(2) polymerizing the oligomer thereby forming the low dielectric constant polymer wherein the polymerization comprises a chemical reaction of the ethynyl group. Preferably, the adhesion promoter (b) is selected from the (i) polycarbosilanes, (ii) silanes, (iii) phenol-formaldehyde resins or oligomers, (iv) glycidyl ethers, (v) unsaturated carboxylic acid esters, or (vi) vinyl cyclic oligomers or polymers set forth above.

Also, we have developed spin-on low dielectric constant material comprising: (a) first backbone having first aromatic moiety and first reactive group and second backbone having second aromatic moiety and second reactive group wherein the first and second backbones are crosslinked via the first and second reactive groups in a crosslinking reaction and cage structure covalently bound to at least one of the first and second backbones, wherein the cage structure comprises at least eight atoms; and (b) adhesion promoter comprising compound having at least bifunctionality wherein the bifunctionality may be the same or different and the first functionality is capable of interacting with the first and second backbones and the second functionality is capable of interacting with a substrate when the material is applied to the substrate. Preferably, the adhesion promoter (b) is selected from the (I) polycarbosilanes, (ii) silanes, (iii) phenol-formaldehyde resins or oligomers, (iv) glycidyl ethers, (v) unsaturated carboxylic acid esters, or (vi) vinyl cyclic oligomers or polymers set forth above.

Various objects, features, aspects, and advantages of the present invention will become more apparent from the following detailed description of the preferred embodiments of the invention, along with the accompanying drawings.

### BRIEF DESCRIPTION OF THE DRAWINGS

Table 1 shows some of the representative teachings on low dielectric materials.

FIGS. 1A-1C are contemplated structures for thermosetting monomers.

FIGS. 1D-1E are contemplated structures for thermosetting dimers.

FIGS. 2A-2D are exemplary structures for thermosetting monomers comprising sexiphenylene.

FIGS. 3A-3C are contemplated synthetic schemes for thermosetting monomers.

FIG. 4 is a synthetic scheme to produce substituted adamantanes.

FIG. 5 is a synthetic scheme to produce a low molecular weight polymer with pendent cage structures.

FIG. 6 is a synthetic scheme to produce a low molecular weight polymer with pendent cage structures.

FIG. 7 shows a synthetic scheme to produce thermosetting monomers.

FIGS. 8A-B are structures of various contemplated polymers.

FIGS. 9A-B are synthetic schemes to produce an end-capping molecule with pendent cage structures.

FIG. 10 is schematic structure of a contemplated low dielectric constant material.

FIG. 11 is a synthetic scheme for the preparation of thermosetting component comprising at least two isomers.

FIG. 12 is a synthetic scheme for the preparation of the Reichert 1,3,5,7-tetrakis[4′-(phenylethynyl)phenyl]adamantane (para-isomer).

### DETAILED DESCRIPTION OF THE INVENTION

As used herein, the term “at least two isomers” means at least two different isomers selected from meta, para, and ortho isomers. Preferably, the at least two isomers are meta and para isomers.

As used herein, the term “low dielectric constant polymer” refers to an organic, organometallic, or inorganic polymer with a dielectric constant of approximately 3.0, or lower. The low dielectric material is typically manufactured in the form of a thin layer having a thickness from 100 to 25,000 Angstroms but also may be used as thick films, blocks, cylinders, spheres etc.

As also used herein, the term “backbone” refers to a contiguous chain of atoms or moieties forming a polymeric strand that are covalently bound such that removal of any of the atoms or moiety would result in interruption of the chain.

As further used herein, the term “reactive group” refers to any atom, functionality, or group having sufficient reactivity to form at least one covalent bond with another reactive group in a chemical reaction. The chemical reaction may take place between two identical, or non-identical reactive groups, which may be located on the same or on two separate backbones. It is also contemplated that the reactive groups may react with one or more than one secondary or exogenous crosslinking molecules to crosslink the first and second backbones. Although crosslinking without exogenous crosslinkers presents various advantages, including reducing the overall number of reactive groups in the polymer, and reducing the number of required reaction steps, crosslinking without exogenous crosslinkers also has a few detriments. For example, the amount of crosslinking functionalities cannot typically be adjusted. On the other hand, employing exogenous crosslinkers may be advantageous when the polymerization reaction and crosslinking reaction are chemically incompatible.

As still further used herein, the phrases “cage structure”, “cage molecule”, and “cage compound” are intended to be used interchangeably and refer to a molecule having at least eight atoms arranged such that at least one bridge covalently connects two or more atoms of a ring system. In other words, a cage structure, cage molecule, or cage compound comprises a plurality of rings formed by covalently bound atoms, wherein the structure, molecule, or compound defines a volume, such that a point located within the volume cannot leave the volume without passing through the ring. The bridge and/or the ring system may comprise one or more heteroatoms, and may contain aromatic groups, partially cyclic or acyclic saturated hydrocarbon groups, or cyclic or acyclic unsaturated hydrocarbon groups. Further contemplated cage structures include fullerenes, and crown ethers having at least one bridge. For example, an adamantane or diamantane is considered a cage structure, while a naphthalene or an aromatic spirocompound are not considered a cage structure under the scope of this definition, because a naphthalene or an aromatic spirocompound do not have one, or more than one bridge and thus, do not fall within the description of the cage compound above.

As used herein, the phrase “adhesion promoter” means any component that when added to thermosetting component (a) or polymer, improves the adhesion thereof to substrates compared with thermosetting component (a) alone or polymer alone. As used herein, the phrase “compound having at least bifunctionality” means any compound having at least two functional groups capable of interacting or reacting, or forming bonds as follows. The functional groups may react in numerous ways including addition reactions, nucleophilic and electrophilic substitutions or eliminations, radical reactions, etc. Further alternative reactions may also include the formation of non-covalent bonds, such as Van der Waals, electrostatic bonds, ionic bonds, and hydrogen bonds.

The term “layer” as used herein includes film and coating.

Thermosetting Component (a):

Thermosetting component (a) and polymer are disclosed in commonly assigned pending U.S. Ser. No. 09/618945 filed Jul. 19, 2000; U.S. Ser. No. 09/897936 filed Jul. 5, 2001; PCT/US01 /22204 filed Oct. 17, 2001; U.S. Ser. No. 09/545058 filed Apr. 7, 2000; and U.S. Ser. No. 09/902924 filed Jul. 10, 2001, which are all incorporated herein by reference.

Thermosetting component (a) comprises monomer having a general structure shown in Structure 1A

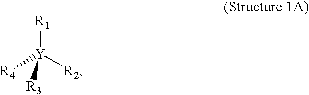

dimer having the general structure shown in Structure 1B

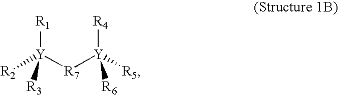

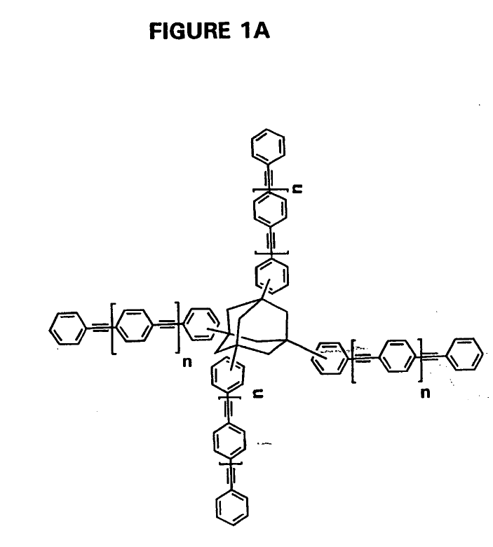

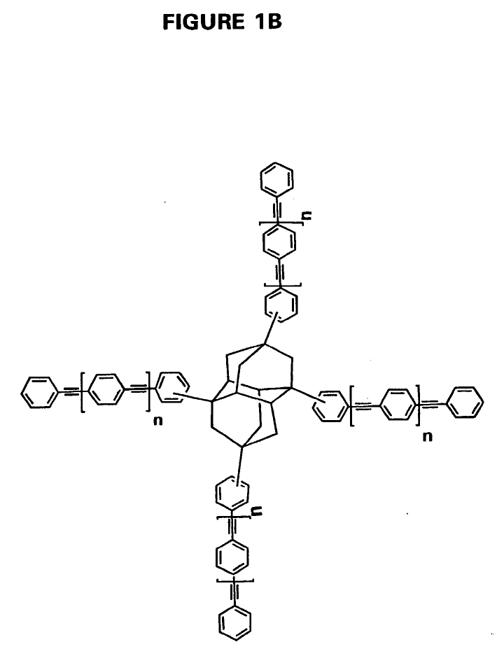

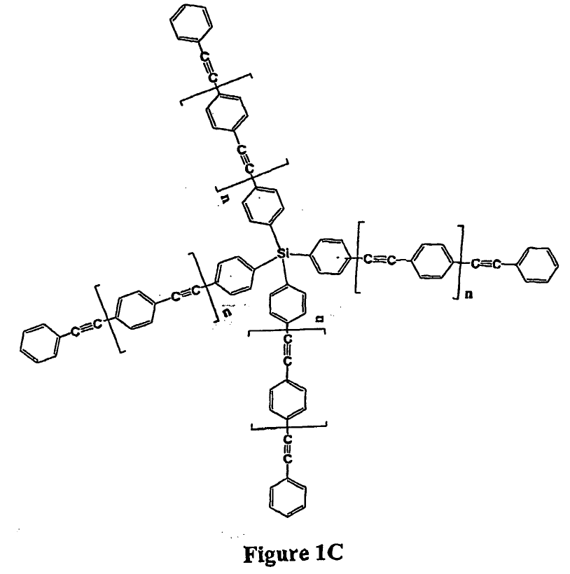

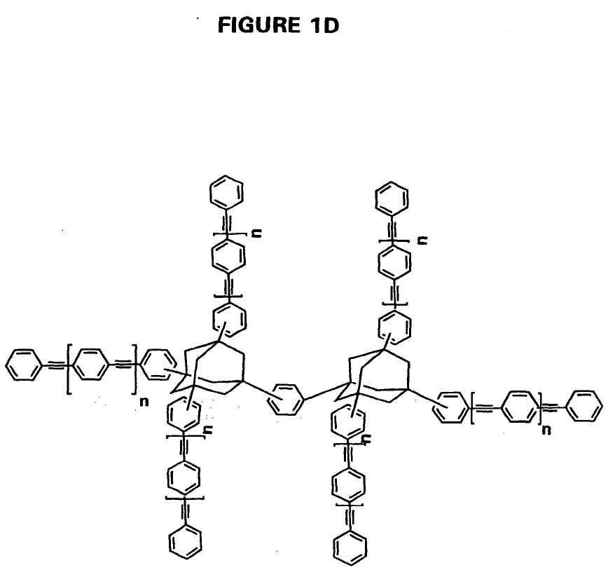

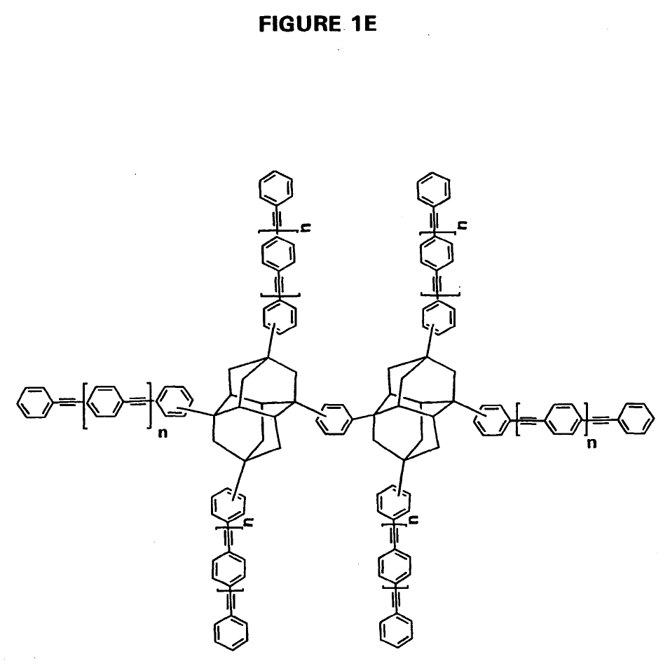

or a mixture of the monomer and dimer wherein Y is selected from cage compound and silicon atom; R₁, R₂, R₃, R₄ R₅, and R₆ are independently selected from aryl, branched aryl, and arylene ether; and at least one of the aryl, the branched aryl, and the arylene ether has an ethynyl group. R₇ is aryl or substituted aryl wherein the substituent is alkyl, halogen, or aryl. As used herein, the term “aryl” without further specification means aryl of any type, which may include, for example branched aryl or arylene ether. Preferably, Y is adamantane or diamantane. Exemplary structures of thermosetting monomers that include adamantane, diamantane, and silicon atom are shown in FIGS. 1A, 1B, and 1C, respectively, wherein n is an integer between zero and five, or more. Exemplary structures of thermosetting dimers that include adamantane and diamantane are shown in FIGS. 1D and 1E respectively, wherein n is an integer between zero and five, or more. Preferably, in thermosetting component (a), a mixture of the monomer and dimer is present. Preferably, the mixture comprises about 95-97 weight percent monomer and about 3-5 weight percent dimer.

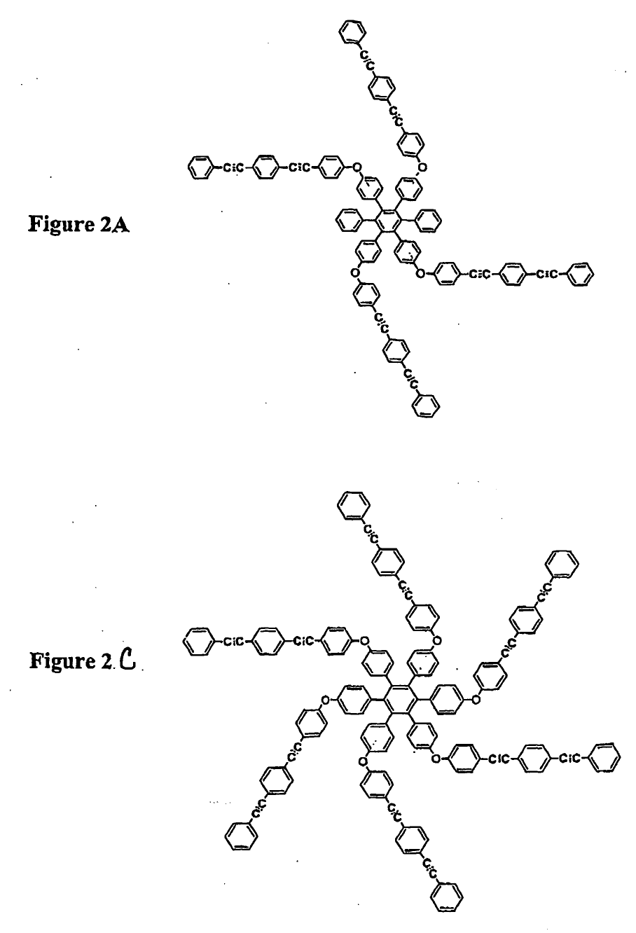

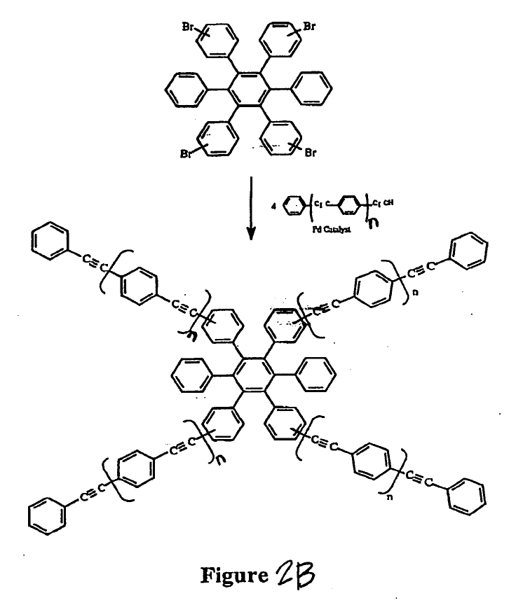

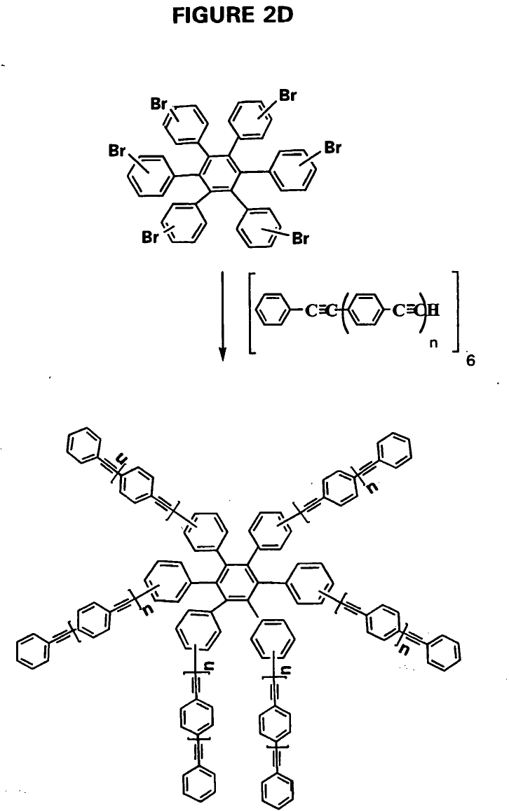

Alternatively, thermosetting monomer (a) has a general structure as shown in Structure 2:

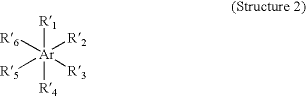

wherein Ar is aryl, and R′₁—R′₆ are independently selected from aryl, branched aryl, arylene ether, and no substitution, and wherein each of the aryl, the branched aryl, and the arylene ether has at least one ethynyl group. Exemplary structures of thermosetting monomers that include a tetra-, and a hexasubstituted sexiphenylene are shown in FIGS. 2A-2B and 2C-2D, respectively.

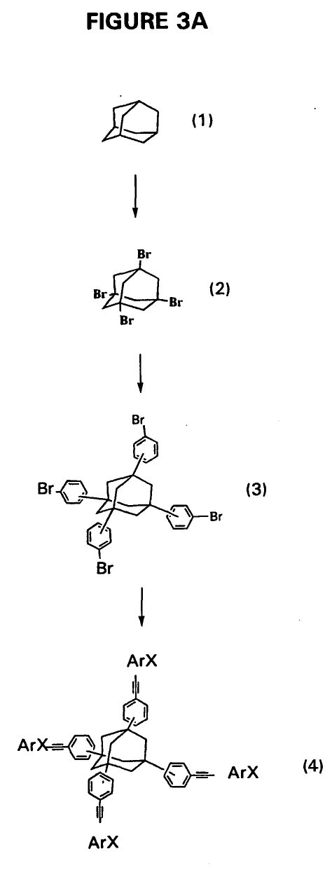

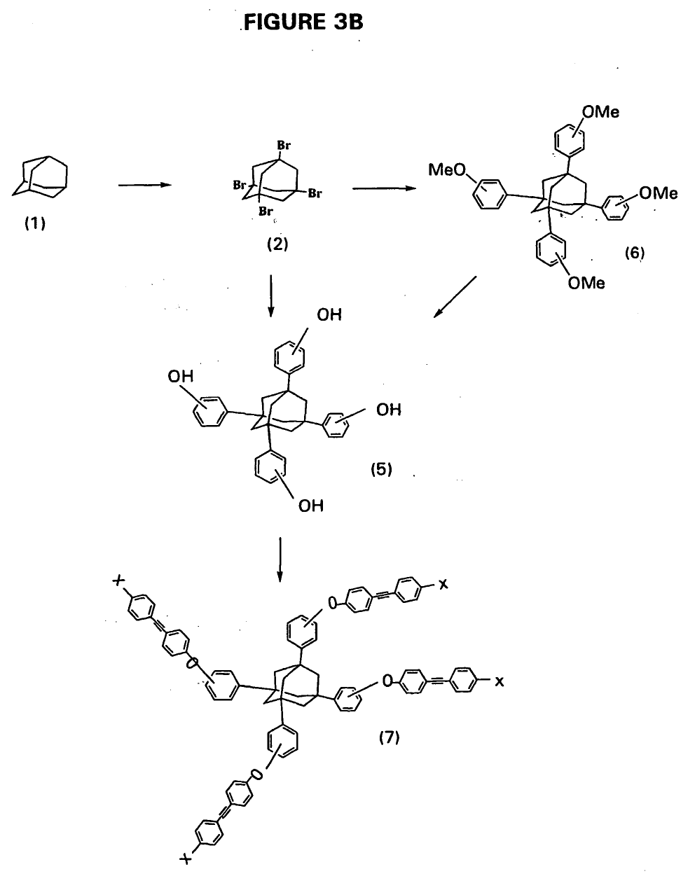

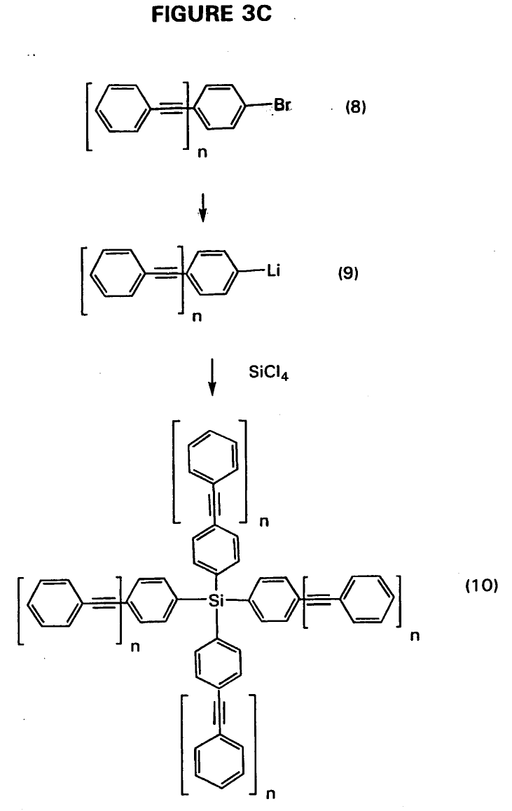

Thermosetting monomers, as generally shown in Structures 1A and 1B and 2, may be provided by various synthetic routes, and exemplary synthetic strategies for Structures 1A and 1B and 2 are shown in FIGS. 3A-3C. FIG. 3A depicts and Example 5 describes a preferred synthetic route for the generation of contemplated thermosetting monomers with adamantane as cage compound, in which a bromoarene is phenylethynylated in a palladium catalyzed Heck reaction. First, adamantane (1) is brominated to 1,3,5,7-tetrabromoadamantane (TBA) (2) following a procedure previously described (J. Org. Chem. 45, 5405-5408 (1980) by Sollot, G. P. c and Gilbert, E. E.). TBA is reacted with phenyl bromide to yield 1,3,5,7-tetra(3′/4′-bromophenyl)adamantane (TBPA) (3) as described in Macromolecules, 27, 7015-7022 (1990) by Reichert, V. R, and Mathias L. J., and TBPA is subsequently reacted with a substituted ethynylaryl in a palladium catalyzed Heck reaction following standard reaction procedures to yield 1,3,5,7-tetrakis[3/4-(arylethynyl)phenyl]adamantane (4). Example 5 goes on to show the differences between the Reichert work and compound described in the Background Section and the contemplated thermosetting component (a). The palladium-catalyzed Heck reaction may also be utilized for the synthesis of a thermosetting monomer with a sexiphenylene as the aromatic portion as shown in FIGS. 2A-2D, in which a tetrabromosexiphenylene and a hexabromosexiphenylene, respectively, is reacted with an ethynylaryl compound to yield the desired corresponding thermosetting monomer.

Alternatively, TBA can be converted to a hydroxyarylated adamantane, which is subsequently transformed into a thermosetting monomer in a nucleophilic aromatic substitution reaction. In FIG. 3B, TBA (2) is generated from adamantane (1) as previously described, and further reacted in an electrophilic tetrasubstitution with phenol to yield 1,3,5,7-tetrakis(3′/4′-hydroxyphenyl)adamantane (THPA) (5). Alternatively, TBA can also be reacted with anisole to give. 1,3,5,7-tetrakis(3′/4′-methoxyphenyl)adamantane (6), which can further be reacted with BBr₃ to yield THPA (5). THPA can then be reacted in various nucleophilic aromatic substitution reactions with activated fluoroaromatics in the presence of potassium carbonate employing standard procedures (e.g., Engineering Plastics—A Handbook of Polyarylethers by R. J. Cotter, Gordon and Breach Publishers, ISBN 2-88449-112-0) to produce the desired thermosetting monomers, or THPA may be reacted with 4-halo-4′-fluorotolane (with halo=Br or I) in a standard aromatic substitution reaction (e.g., Engineering Plastics, supra) to yield 1,3,5,7-tetrakis{3′/4′-[4″-(halophenylethynyl)phenoxy]phenyl}adamantane (7). In further alternative reactions, various alternative reactants may also be utilized to generate the thermosetting monomers. Similarly, the nucleophilic aromatic substitution reaction may also be utilized in a synthesis of a thermosetting monomer with a sexiphenylene as the aromatic portion, in which sexiphenylene is reacted with 4-fluorotolane to produce a thermosetting monomer. Alternatively, phloroglucinol may be reacted in a standard aromatic substitution reaction with 4-[4′-(fluorophenylethynyl)phenylethynyl]benzene to yield 1,3,5-tris{4′-[4″-(phenylethynyl)phenylethynyl]phenoxy}benzene.

Where the cage compound is a silicon atom, an exemplary preferred synthetic scheme is depicted in FIG. 3C, in which bromo(phenylethynyl)aromatic arms (8) where n is an integer between zero and five or more are converted into the corresponding (phenylethynyl)aryl lithium arms (9), which are subsequently reacted with silicon tetrachloride to yield the desired star-shaped thermosetting monomer with a silicon atom as a cage compound (10).

It is preferred that the cage compound is a silicon atom, an adamantane, a diamantane, or a plurality of adamantanes or diamantanes. In alternative aspects of the inventive subject matter, various cage compounds other than an adamantane or diamantane are also contemplated. It should be especially appreciated that the molecular size and configuration of the cage compound in combination with the overall length of the arms R₁—R₆ or R′₁—R′₆ will determine several of the physical and mechanical properties, in the final low dielectric constant polymer (by steric effect). Therefore, where relatively small cage compounds are desirable, substituted and derivatized adamantanes, diamantanes, and relatively small, bridged cyclic aliphatic and aromatic compounds (with typically less than 15 atoms) are contemplated. In contrast, in cases where larger cage compounds are desirable, larger bridged cyclic aliphatic and aromatic compounds (with typically more than 15 atoms) and fullerenes are contemplated.

Contemplated cage compounds need not necessarily be limited to being comprised solely of carbon atoms, but may also include heteroatoms such as N, S, O, P, etc. Heteroatoms may advantageously introduce non-tetragonal bond angle configurations, which may in turn enable covalent attachment of arms R₁—R₆ or R′₁—R′₆ at additional bond angles. With respect to substituents and derivatizations of contemplated cage compounds, it should be recognized that many substituents and derivatizations are appropriate. For example, where the cage compounds are relatively hydrophobic, hydrophilic substituents may be introduced to increase solubility in hydrophilic solvents, or vice versa. So, in cases where polarity is desired, polar side groups may be added to the cage compound. It is further contemplated that appropriate substituents may also include thermolabile groups and nucleophilic and electrophilic groups. It should also be appreciated that functional groups may be utilized in the cage compound (e.g., to facilitate crosslinking reactions, derivatization reactions, etc.). Where the cage compounds are derivatized, it is especially contemplated that derivatizations include halogenation of the cage compound, and particularly preferred halogens are fluorine and bromine.

Where the thermosetting monomer (a) has an aryl coupled to the arms R′₁—R′₆ as shown in Structure 2, it is preferred that the aryl comprises a phenyl group, and it is even more preferred that the aryl is a phenyl group to form a sexiphenylene. In alternative aspects of the inventive subject matter, it is contemplated that various aryl compounds other than a phenyl group (or a sexiphenylene) are also appropriate, including substituted and unsubstituted bi- and polycyclic aromatic compounds. Substituted and unsubstituted bi- and polycyclic aromatic compounds are particularly advantageous where increased size of the thermosetting monomer is preferred. For example, where it is desirable that alternative aryls extend in one dimension more than in another dimension, naphthalene, phenanthrene, and anthracene are particularly contemplated. In other cases, where it is desirable that alternative aryls extend symmetrically; polycyclic aryls such as a coronene are contemplated. In especially preferred aspects, contemplated bi- and polycyclic aryls have conjugated aromatic systems that may or may not include heteroatoms. With respect to substitutions and derivatizations of contemplated aryls, the same considerations apply as for cage compounds, as discussed herein.

With respect to the arms R₁—R₆ and R′₁—R′₆, it is preferred that R₁—R₆ are individually selected from an aryl, a branched aryl, and an arylene ether, and R′₁—R′₆ are individually selected from an aryl, a branched aryl, and an arylene ether, and no substitution. Particularly contemplated aryls for R₁—R₆ and R′₁—R′₆ include aryls having a (phenylethynyl)phenyl, a phenylethynyl(phenylethynyl)phenyl, and a (phenylethynyl)phenylphenyl moiety. Especially preferred arylene ethers include (phenylethynylphenyl)phenyl ether. Particularly contemplated aryls for R₇ include phenyl and substituted aryls such as phenyl substituted with hydrogen, alkyl, aryl, or halogen.

In alternative aspects of the inventive subject matter, appropriate arms of the thermosetting components need not be limited to an aryl, a branched aryl, and an arylene ether, so long as alternative arms R₁—R₆ and R′₁—R′₆ comprise a reactive group, and so long as the polymerization of the thermosetting component comprises a reaction involving the reactive group. For example, contemplated arms may be relatively short with no more than six atoms, which may or may not be carbon atoms. Such short arms may be especially advantageous where voids or pores are desirable to add to the final product or material and the size of voids needs to be relatively small. In contrast, where especially long arms are preferred, the arms may comprise an oligomer or polymer with 7-40, and more atoms. These long arms can be advantageous to design in material stability, thermal stability or even porosity, as compared to the smaller arms. Furthermore, the length as well as the chemical composition of the arms covalently coupled to the contemplated thermosetting monomers may vary within one monomer. For example, a cage compound may have two relatively short arms and two relatively long arms to promote dimensional growth in a particular direction during polymerization. In another example, a cage compound may have two arms chemically distinct from another two arms to promote regioselective derivatization reactions.

While it is preferred that all of the arms in a thermosetting component have at least one reactive group, in alternative aspects less than all of the arms need to have a reactive group. For example, a cage compound may have four arms, and only three or two of the arms carry a reactive group. Alternatively, an aryl in a thermosetting component may have three arms wherein only two or one arm has a reactive group. It is generally contemplated that the number of reactive groups in each of the arms R₁—R₆ and R′₁—R′₆ may vary considerably, depending on the chemical nature of the arms and of the qualities of the desired end product. Moreover, reactive groups are contemplated to be positioned in any part of the arm, including the backbone, side chain or terminus of an arm. It should be especially appreciated that the number of reactive groups in the thermosetting component (a) may be utilized as a tool to control the degree of crosslinking. For example, where a relatively low degree of crosslinking is desired, contemplated thermosetting monomers may have only one or two reactive groups, which may or may not be located in one arm. On the other hand, where a relatively high degree of crosslinking is required, three or more reactive groups may be included into the monomer. Preferred reactive groups include electrophilic and nucleophilic groups, more preferably groups that may participate in a cycloaddition reaction and a particularly preferred reactive group is an ethynyl group.

In addition to reactive groups in the arms, other groups, including functional groups may also be included into the arms. For example, where addition of particular functionalities (e.g., a thermolabile portion) after the polymerization of the thermosetting monomer into a polymer is desirable, such functionalities may be covalently bound to the functional groups.

The thermosetting component (a) may be polymerized by a large variety of mechanisms, and the actual mechanism of polymerization predominantly depends on the reactive group-that participates in the polymerization process. Therefore, contemplated mechanisms include nucleophilic, electrophilic and aromatic substitutions, additions, eliminations, radical polymerization reactions, and cycloaddition reaction, and a particularly preferred polymerization mechanism is a cycloaddition that involves at least one ethynyl group located at least one of the arms. For example, in a thermosetting component (a) having arms selected from an aryl, a branched aryl and an arylene ether, in which at least three of the aryl, the branched aryl, and the arylene ether have a single ethynyl group, the polymerization of the thermosetting component (a) may comprise a cycloaddition reaction (i.e. a chemical reaction) of at least two of the ethynyl groups. In another example, in a thermosetting monomer (a) wherein all of the aryl, the branched aryl, and the arylene ether arms have a single ethynyl group, the polymerization process may comprise a cycloaddition reaction (i.e. a chemical reaction) of the ethynyl groups. In other examples, cycloaddition reaction (e.g., a Diels-Alder reaction) may occur between an ethynyl group in at least one arm of the thermosetting monomer (a) and a diene group located in a polymer. It is further contemplated that the polymerization of the thermosetting component (a) takes place without participation of an additional molecule (e.g., a crosslinker), preferably as a cycloaddition reaction between reactive groups of thermosetting monomers (a). However, in alternative aspects of the inventive subject matter, crosslinkers may be utilized to covalently couple thermosetting component (a) to a polymer. Such covalent coupling may thereby either occur between a reactive group and a polymer or a functional group and a polymer.

Depending on the mechanism of polymerization of the thermosetting component (a), reaction conditions may vary considerably. For example, where a monomer is polymerized by a cycloaddition reaction utilizing an ethynyl group of at least one of the arms, heating of the thermosetting monomer to approximately 250° C. or greater for about 45 minutes is generally sufficient. In contrast, where the monomer is polymerized by a radical reaction, addition of a radical starter may be appropriate. Preferred polymerization methods and techniques are set forth in the examples.

The thermosetting component may be located at any point in or on the polymer backbone, including the terminus or as a side chain of the polymer.

Contemplated polymers include a large variety of polymer types such as polyimides, polystyrenes, polyamides, etc. However, it is especially contemplated that the polymer comprises a polyarylene, more preferably a poly(arylene ether). In an even more preferred aspect, the polymer is fabricated at least in part from the thermosetting monomer, and it is particularly contemplated that the polymer is entirely fabricated from isomers of the thermosetting component.

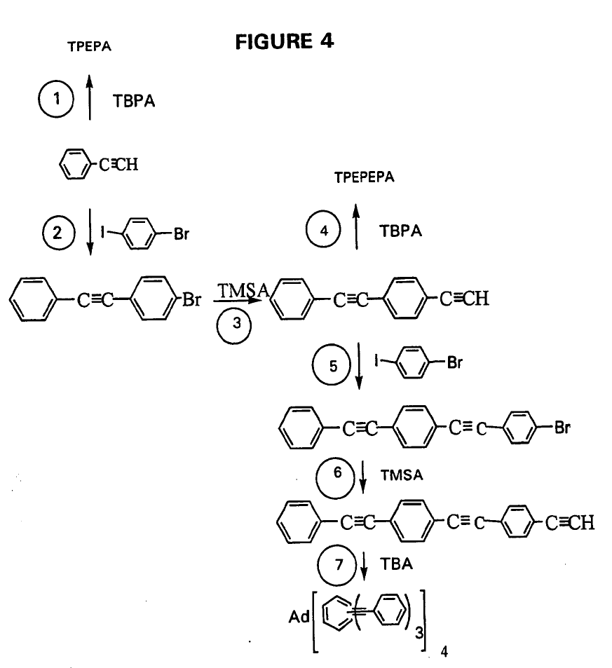

In an especially contemplated arm extension strategy depicted in FIG. 4, in which Ad represents an adamantane or diamantane group, phenylacetylene is a starting molecule that is reacted (1) with TBPA (supra) to yield 1,3,5,7-tetrakis[3′/4′-(phenylethynyl)phenyl]adamantane (TPEPA). Alternatively, phenylacetylene can be converted (2) to 4-(phenylethynyl)phenylbromide that is subsequently reacted (3) with trimethylsilylacetylene (TMSA) to form 4-(phenylethynyl)phenylacetylene. TBPA can then be reacted (4) with 4-(phenylethynyl)phenylacetylene to yield 1,3,5,7-tetrakis{3′/4′-[4″-(phenylethynyl)phenylethynyl]phenyl}adamantane (TPEPEPA). In a further extension reaction, 4-(phenylethynyl)phenylacetylene is reacted (5) with 1-bromo-4-iodobenzene to form 4-[4′-(phenylethynyl)phenylethynyl]phenylbromide that is further converted (6) to 4-[4′-(phenylethynyl)phenylethynyl]acetylene. The so formed 4-[4′-(phenylethynyl)phenylethynyl]acetylene may then be reacted (7) with TBA to yield 1,3,5,7-tetrakis-{3′/4′-[4″-(4″′-(phenylethynyl)phenylethynyl)phenylethynyl]phenyl}adamantane.

The present invention also provides a spin-on low dielectric constant polymer comprising:

(a) polymer having pendant cage structure —[OR₂₄(R₂₆)ₘOR₂₆]ₙ—wherein R₂₄ is —C₆H₃—; R₂₅ is adamantane, diamantane, (C₆H₅)ₚ(adamantane), or (C₆H₅)ₚ(diamantane); m=1-3; n=1-10³ ; p=0 or 1; and R₂₆ is a radical of 2,3,4,5-(tetraphenyl)cyclodienone-1. or

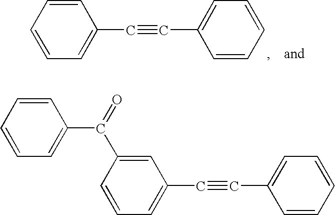

and (b) adhesion promoter comprising compound having at least bifunctionality wherein the bifunctionality may be the same or different and the first functionality is capable of interacting with the polymer having pendant cage structures and the second functionality is capable of interacting with a substrate when the composition is applied to the substrate. Preferably, the adhesion promoter (b) is selected from the (i) polycarbosilanes, (ii) silanes, (iii) phenol-formaldehyde resins or oligomers, (iv) glycidyl ethers, (v) unsaturated carboxylic acid esters, or (vi) vinyl cyclic oligomers or polymers set forth above.

As stated earlier, the present invention also provides a spin-on low dielectric constant material, comprising: (a) first backbone having a first aromatic moiety and a first reactive group; second backbone having a second aromatic moiety and a second reactive group, wherein the first and second backbones are crosslinked via the first and second reactive groups in a crosslinking reaction; and a cage structure covalently bound to at least one of the first and second backbones, wherein the cage structure comprises at least eight atoms; and (b) adhesion promoter comprising compound having at least bifunctionality wherein the bifunctionality may be the same or different and the first functionality is capable of interacting with the first and second backbones and the second functionality is capable of interacting with a substrate when the composition is applied to the substrate.

At least one backbone may comprise a poly(arylene ether) with two pendent adamantane groups, respectively, as cage structures as shown in Structures 3A-B (only one repeating unit of the backbone is shown). Preferred crosslinking conditions are heating the poly(arylene ether) backbones to a temperature of about 200° C.-250° C. or greater for approximately 30-180 minutes. Structure 3B may be synthesized as generally outlined in Examples 1-3 below.

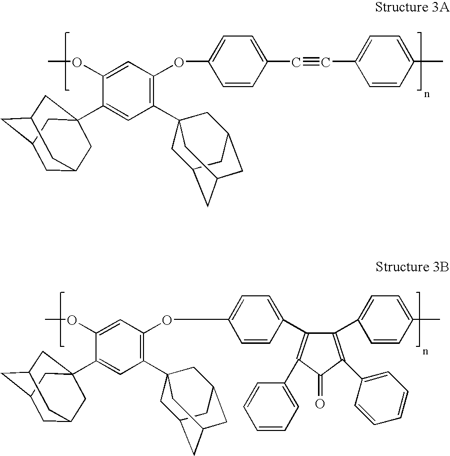

The first and second aromatic moieties comprise a phenyl group, and the first and second reactive groups are an ethynyl, a tetracyclone, or both an ethynyl and a tetracyclone moiety, respectively, which react in a Diels-Alder reaction to cross-link the backbones.

In alternative embodiments, the backbone need not be restricted to a poly(arylene ether), but may vary greatly depending on the desired physico-chemical properties of the final low dielectric constant material. Consequently, when relatively high T_{g} is desired, inorganic materials are especially contemplated, including inorganic polymers comprising silicate (SiO₂) and/or aluminate (Al₂O₃). In cases where flexibility, ease of processing, or low stress/TCE, etc. is required, organic polymers are contemplated. Thus, depending on a particular application, contemplated organic backbones include aromatic polyimides, polyamides, and polyesters.

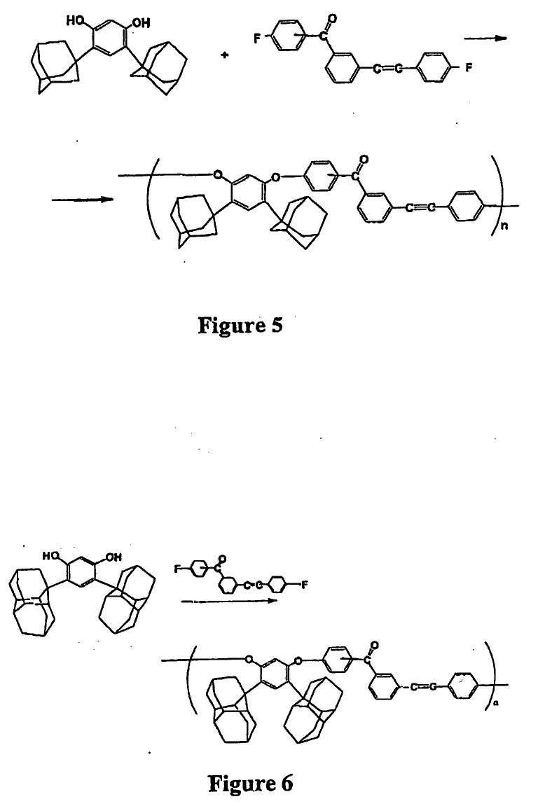

Although preferably built from low molecular weight polymers with a molecular weight of approximately 1000 to 10000, the chain length of the first and second polymeric backbones may vary considerably between five, or less repeating units, to several 10⁴ repeating units, and more. Preferred backbones are synthesized from monomers in an aromatic substitution reaction, and synthetic routes are shown by way of example in FIGS. 5 and 6. It is further contemplated that alternative backbones may also be branched, superbranched, or crosslinked at least in part. Alternatively, the backbones may also be synthesized in-situ from monomers. Appropriate monomers may preferably include aromatic bisphenolic compounds and difluoroaromatic compounds, which may have between 0 and about 20 built-in cage structures.

It is again contemplated that appropriate thermosetting components (a) may have or comprise a tetrahedral structure, which are schematically depicted in Structures 1A and 1B or 4A and 4B. In general Structures 1A and 1B, a thermosetting monomer has a cage structure Y, and at least two of the side chains R₁—R₆ comprise an aromatic portion and a reactive group, wherein at least one of the reactive groups of a first monomer reacts with at least one of the reactive group of a second monomer to produce a low dielectric constant polymer. In general Structure 4A, a cage structure, preferably an adamantane, is coupled to four aromatic portions which may participate in polymerization, and wherein R₁—R₄ may be identical or different. At least one of R₁, R₂, R₃, and R₄ comprises at least two isomers. In general Structure 4B, each cage structure preferably an adamantane is coupled to three aromatic portions which may participate in polymerization and wherein R₁—R₆ may be identical or different and two of these cage structures are joined by an aryl or substituted aryl. At least one of R₁, R₂, R₃, R₄, R₅, and R₆ comprises at least two isomers. Preferably, at least two isomers of the adamantanes relative to R₇ exist.

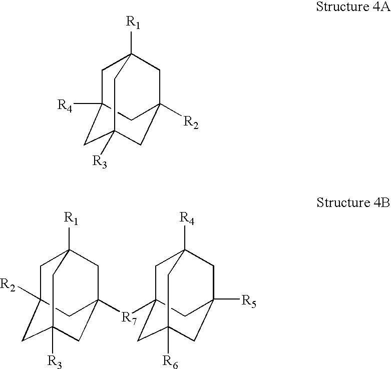

When monomers with tetrahedral structure are used, the cage structure will covalently connect four backbones in a three dimensional configuration. An exemplary monomer with tetrahedral structure and its synthesis is shown in FIG. 3A. It should further be appreciated that alternative monomers need not be limited to compounds with a substituted or unsubstituted adamantane as a cage structure, but may also comprise any cycloalkyl or cycloalkylene structure, cubane, a substituted or unsubstituted diamantane, or fullerene as a cage structure. Contemplated substituents include alkyls, aryls, halogens, and functional groups. For example, an adamantane may be substituted with a —CF3 group, tertiary alkyl group having from one to ten carbon atoms, a phenyl group, —COOH, —NO₂, or —F, —Cl, or —Br. Consequently, depending on the chemical nature of the cage structure, various numbers other than four aromatic portions may be attached to the cage structure. For example, where a relatively low degree of crosslinking through cage structures is desired, one to three aromatic portions may be attached to the cage structure, wherein the aromatic portions may or may not comprise a reactive group for crosslinking. In cases where higher degrees of crosslinking is preferred, four and more aromatic portions may be attached to a cage structure wherein all or almost all of the aromatic portions carry one or more than one reactive group. Furthermore, it is contemplated that aromatic portions attached to a central cage structure may carry other cage structures, wherein the cage structures may be identical to the central cage structure, or may be entirely different. For example, contemplated monomers may have a fullerene cage structure to provide a relatively high number of aromatic portions, and a diamantane in the aromatic portions. Thus, contemplated cage structures may be covalently bound to a first and second backbone, or to more than two backbones.

With respect to the chemical nature of the aromatic portion, it is contemplated that appropriate aromatic portions comprise a phenyl group, and more preferably a phenyl group and a reactive group. For example, an aromatic portion may comprise a tolane or (phenylethynylphenyl) group, or a substituted tolane, wherein substituted tolanes may comprise additional phenyl groups covalently bound to the tolane via carbon-carbon bonds, or carbon-non-carbon atom bonds, including double and ethynyl groups, ether-, keto-, or ester groups.

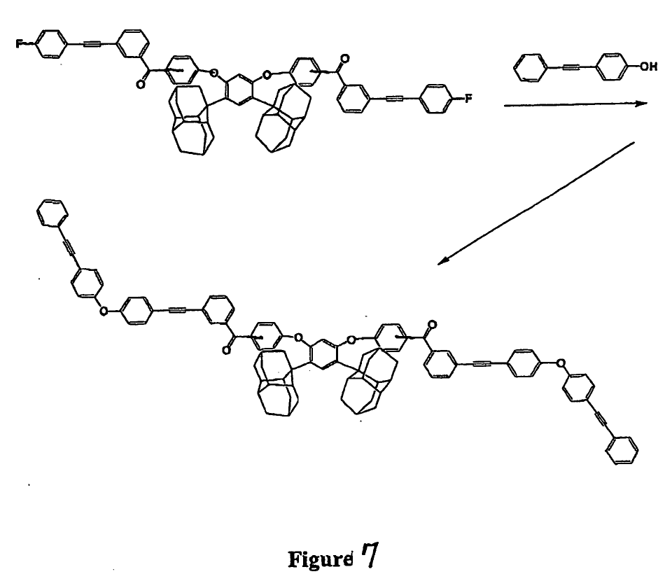

Also contemplated are monomers that have pendent cage structures, as depicted by way of example in FIG. 7, in which two diamantane groups are utilized as pendent groups. It should be appreciated, however, that pending cage structures are not limited to two diamantane structures. Contemplated alternative cage structures include single and multiple substituted adamantane groups, diamantane groups and fullerenes in any chemically reasonable combination. Substitutions may be introduced into the cage structures in cases where a particular solubility, oxidative stability, or other physico-chemical properties are desired. Therefore, contemplated substitutions include halogens, alkyl, aryl, and alkenyl groups, but also functional and polar groups including esters, acid groups, nitro and amino groups, and so forth.

It should also be appreciated that the backbones need not be identical. In some aspects of alternative embodiments, two, or more than two chemically distinct backbones may be utilized to fabricate a low dielectric constant material, as long as the alternative low dielectric constant material comprises first and second backbones having an aromatic moiety, a reactive group, and a cage compound covalently bound to the backbone.

With respect to the reactive groups, it is contemplated that many reactive groups other than an ethynyl group and a tetracyclone group may be utilized, so long as alternative reactive groups are able to crosslink first and second backbones without an exogenous crosslinker. For example, appropriate reactive groups include benzocyclobutenyl. In another example, a first reactive group may comprise an electrophile, while a second reactive group may comprise a nucleophile. It is further contemplated that the number of reactive groups predominantly depends on (a) the reactivity of the first and second reactive group, (b) the strength of the crosslink between first and second backbone, and (c) the desired degree of crosslinking in the low dielectric material. For example, when the first and second reactive groups are sterically hindered (e.g. an ethynyl group between two derivatized phenyl rings), a relatively high number of reactive groups may be needed to crosslink two backbones to a certain extent. Likewise, a high number of reactive groups may be required to achieve stable crosslinking when relatively weak bonds such as hydrogen bonds or ionic bonds are formed between the reactive groups.

In cases where a reactive group in one backbone is capable of reacting with an identical reactive group in another backbone, only one type of reactive group may be needed. For example, ethynyl groups located on the same of two different backbones may react in an addition and cycloaddition-type reaction to form crosslinking structures.

It should also be appreciated that the number of reactive groups may influence the ratio of intermolecular to intramolecular crosslinking. For example, a relatively high concentration of reactive groups in first and second backbones at a relatively low concentration of both backbones may favor intramolecular reactions. Similarly, a relatively low concentration of reactive groups in first and second backbones at a relatively high concentration of both backbones may favor intermolecular reactions. The balance between intra- and intermolecular reactions may also be influenced by the distribution of non-identical reactive groups between the backbones. When an intermolecular reaction is desired, one type of reactive group may be placed on the first backbone, while another type of reactive group may be positioned on the second backbone. Furthermore, additional third and fourth reactive groups may be utilized when sequential crosslinking at different conditions is desired (e.g. two different temperatures).

The reactive groups of preferred backbones react in an addition-type reaction, however, depending on the chemical nature of alternative reactive groups, many other reactions are also contemplated, including nucleophilic and electrophilic substitutions, or eliminations, radical reactions, etc. Further alternative reactions may also include the formation of non-covalent bonds, such as electrostatic bonds, ionic bonds, and hydrogen bonds. Thus, crosslinking the first and second backbone may occur via a covalent or non-covalent bond formed between identical or non-identical reactive groups, which may be located on the same or two backbones.

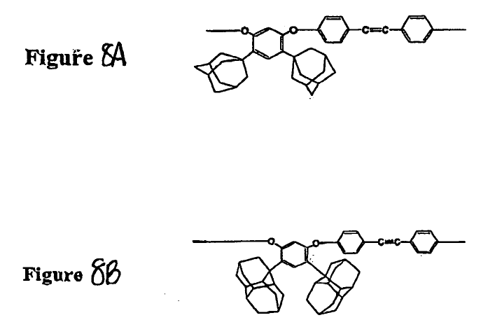

In further aspects of alternative embodiments, the cage structure may comprise structures other than an adamantane, including a diamantane, bridged crown ethers, cubanes, or fullerenes, as long as alternative cage structures have at least eight atoms. The selection of appropriate cage structures is determined by the desired degree of steric demand of the cage structure. If relatively small cage structures are preferred, a single adamantane, or diamantane group may be sufficient. Contemplated structures of backbones including adamantane and diamantane groups are shown in FIGS. 8A and 8B. Large cage structures may comprise fullerenes. It should also be appreciated that alternative backbones need not be limited to a single type of cage structure. Appropriate backbones may also include two to five cage structures or other molecules and more non-identical cage structures. For example, fullerenes may be added to one or both ends of a polymeric backbone, while diamantane groups are placed in the other parts of the backbone. Further contemplated are derivatized, or multiple cage structures, including oligomerized and polymerized cage structures, where even larger cage structures are desired. The chemical composition of the cage structures need not be limited to carbon atoms, and it should be appreciated that alternative cage structures may have atoms other than carbon atoms (i.e. heteroatoms), whereby contemplated heteratoms may include N, O, P, S, B, etc.

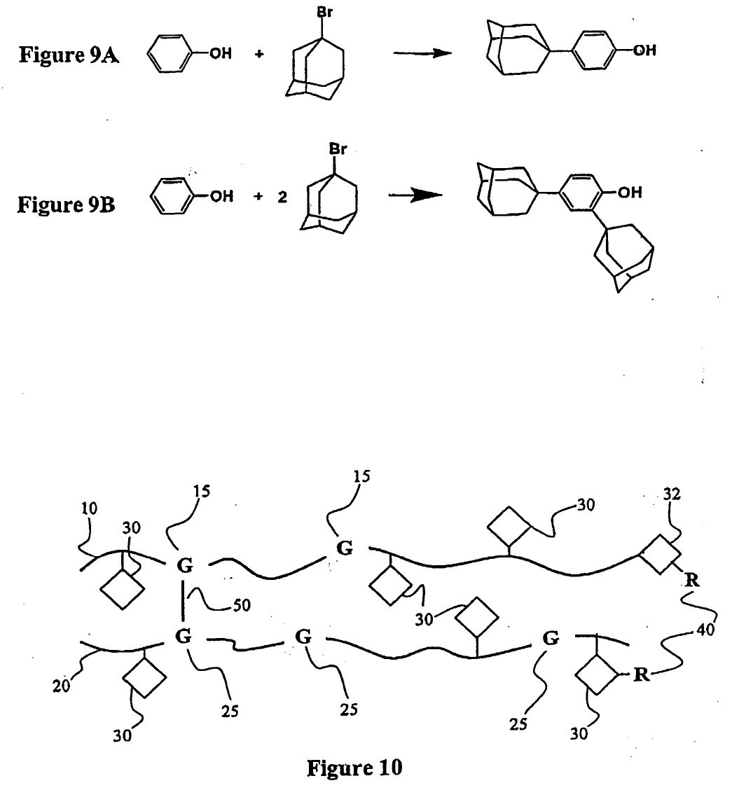

With respect to the position of the cage structure, it is contemplated that the cage structure may be connected to the backbone in various locations. For example, when it is desirable to mask terminal functional groups in the backbone, or to terminate a polymerization reaction forming a backbone, the cage structure may be utilized as an end-cap. Exemplary structures of end-caps are shown in FIGS. 9A and 9B. In other cases where large amounts of a cage structure are desired, it is contemplated that the cage structures are pendent structures covalently connected to the backbone. The position of the covalent connection may vary, and mainly depends on the chemical make-up of the backbone and the cage structure. Thus, appropriate covalent connections may involve a linker molecule, or a functional group, while other connections may be a single or double bond. When the cage group is a pendent group, it is especially contemplated that more than one backbone may be connected to the cage structure. For example, a single cage structure may connect at least two or three or and more backbones. Alternatively, it is contemplated that the cage group may be an integral part of the backbone.

Turning now to FIG. 10, an exemplary polymer is shown in which a first backbone 10 is crosslinked to a second backbone 20 via a first reactive group G15 and a second reactive group G25, wherein the crosslinking results in a covalent bond 50. Both backbones have at least one aromatic moiety (not shown), respectively. A plurality of pendent cage structures 30 are covalently bound to the first and second backbones, and the first backbone 10 further has a terminal cage group 32. The terminal cage group 32, and at least one of the pendent cage groups 30 carries at least one substituent R (40), wherein substituent 40 may be a halogen, alkyl, or aryl group. Each of the cage structures comprises at least eight (8) atoms.

Adhesion Promoter (b):

One adhesion promoter is silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, saturated or unsaturated alkoxyl, unsaturated or saturated carboxylic acid radical, or aryl wherein at least two of R₁₆, R₁₉, R₂₀, and R₂₁ represent hydrogen, hydroxyl, saturated or unsaturated alkoxyl, unsaturated alkyl, or unsaturated carboxylic acid radical; and f+g+h+i≦4. Examples include vinylsilanes such as H₂C═CHSi(CH₃)₂H and H₂C═CHSi(R₂₇)₃ where R₂₇ is CH₃O, C₂H₅O, AcO, H₂C═CH, or H₂C═C(CH₃)O—, or vinylphenylmethylsilane; allylsilanes of the formula H₂C═CHCH₂—Si(OC₂H₆)₃ and H₂C═CHCH₂—Si(H)(OCH₃)₂; glycidoxypropylsilanes such as (3-glycidoxypropyl)methyldiethoxysilane and (3-glycidoxypropyl)trimethoxysilane; methacryloxypropylsilanes of the formula H₂C═(CH₃)COO(CH₂)₃—Si(OR₂₈)₃ where R₂₈ is an alkyl, preferably methyl or ethyl; aminopropylsilane derivatives including H₂N(CH₂)₃Si(OCH₂CH₃)₃, H₂N(CH₂)₃Si(OH)₃, or H₂N(CH₂)₃OC(CH₃)₂CH ═CHSi(OCH₃)₃. The aforementioned silanes are commercially available from Gelest.

Another useful adhesion promoter is phenol-formaldehyde resins or oligomers of the formula —[R₂₂C₆H₂(OH)(R₂₃)]ᵢ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100. Examples of useful alkyl groups include —CH₂— and —(CH₂)ₖ— where k>1. A particularly useful phenol-formaldehyde resin oligomer has a molecular weight of 1500 and is commercially available from Schenectady International.

Another useful adhesion promoter is glycidyl ethers including but not limited to 1,1,1-tris-(hydroxyphenyl)ethane tri-glycidyl ether which is commercially available from TriQuest.

Another useful adhesion promoter is esters of unsaturated carboxylic acids containing at least one carboxylic acid group. Examples include trifunctional methacrylate ester, trifunctional acrylate ester, trimethylolpropane triacrylate, dipentaerythritol pentaacrylate, and glycidyl methacrylate. The foregoing are all commercially available from Sartomer.

Other useful adhesion promoters are vinyl cyclic pyridine oligomers or polymers wherein the cyclic group is pyridine, aromatic, or heteroaromatic. Useful examples include but not limited to 2-vinylpyridine and 4-vinylpyridine, commercially available from Reilly; vinyl aromatics; and vinyl heteroaromatics including but not limited to vinyl quinoline, vinyl carbazole, vinyl imidazole, and vinyl oxazole.

Preferably adhesion promoter (b) is the polycarbosilane disclosed in commonly assigned copending U.S. patent application Ser. No. 09/471299 filed Dec. 23, 1999 incorporated herein by reference in its entirety. The polycarbosilane is of the formula (I):

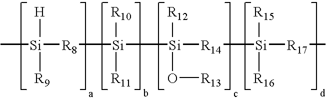

in which R₈ , R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom or organo group comprising alkyl, alkylene, vinyl, cycloalkyl, allyl, or aryl and may be linear or branched; R₁₃ represents organosilicon, silanyl, siloxyl, or organo group; and a, b, c, and d satisfy the conditions of [4≦a+b+c+d ≦100,000], and b and c and d may collectively or independently be zero. The organo groups may contain up to 18 carbon atoms but generally contain from about 1 to about 10 carbon atoms. Useful alkyl groups include —CH₂— and —(CH₂)ₑ— where e>1.

Preferred polycarbosilanes of the present invention include dihydrido polycarbosilanes in which R₈is a substituted or unsubstituted alkylene or phenyl, R₉group is a hydrogen atom and there are no appendent radicals in the polycarbosilane chain; that is, b, c, and d are all zero. Another preferred group of polycarbosilanes are those in which the R₉, R₁₀, R₁₁, R₁₂, R₁₅, and R₁₆ groups of formula (I) are substituted or unsubstituted alkenyl groups having from 2 to 10 carbon atoms. The alkenyl group may be ethenyl, propenyl, allyl, butenyl or any other unsaturated organic backbone radical having up to 10 carbon atoms. The alkenyl group may be dienyl in nature and includes unsaturated alkenyl radicals appended or substituted on an otherwise alkyl or unsaturated organic polymer backbone. Examples of these preferred polycarbosilanes include dihydrido or alkenyl substituted polycarbosilanes such as polydihydridocarbosilane, polyallylhydrididocarbosilane and random copolymers of polydihydridocarbosilane and polyallylhydridocarbosilane.

In the more preferred polycarbosilanes, the R₉ group of formula I is a hydrogen atom and R₈ is methylene and the appendent radicals b, c, and d are zero. Other preferred polycarbosilane compounds of the invention are polycarbosilanes of formula I in which R₉and R₁₅ are hydrogen, R₈ and R₁₇ are methylene, and R₁₆ is an alkenyl, and appendent radicals b and c are zero. The polycarbosilanes may be prepared from well known prior art processes or provided by manufacturers of polycarbosilane compositions. In the most preferred polycarbosilanes, the R₉ group of formula (I) is a hydrogen atom; R₈ is —CH₂—; b, c, and d=0 and a=5-25. These most preferred polycarbosilanes may be obtained from Starfire Systems, Inc. Specific examples of these most preferred polycarbosilanes follow:

| | Weight Average | | Peak Molecular |
|---|---|---|---|
| | Molecular Weight | | Weight |
| Polycarbosilane | (Mw) | Polydispersity | (Mp) |
| 1 | 400-1,400 | 2-2.5 | 330-500 |
| 2 | 330 | 1.14 | 320 |
| 3 (with 10% allyl | 10,000-14,000 | 10.4-16 | 1160 |
| groups) | | | |
| 4 (with 75% allyl | 2,400 | 3.7 | 410 |
| groups) | | | |

As can be observed in formula (I), the polycarbosilanes utilized in the subject invention may contain oxidized radicals in the form of siloxyl groups when c>0. Accordingly, R₁₃ represents organosilicon, silanyl, siloxyl, or organo group when c>0. It is to be appreciated that the oxidized versions of the polycarbosilanes (c>0) operate very effectively in, and are well within the purview of the present invention. As is equally apparent, c can be zero independently of a, b, and d the only conditions being that the radicals a, b, c, and d of the formula I polycarbosilanes must satisfy the conditions of [4<a+b+c+d<100,000], and b and c can collectively or independently be zero.

The present polycarbosilanes are preferably added in small, effective amounts from about 0.5% to up to 20% based on the weight of the present thermosetting composition (a) and amounts up to about 5.0 % by weight of the composition are generally more preferred.

The polycarbosilane may be produced from starting materials that are presently commercially available from many manufacturers and by using conventional polymerization processes. As an example of synthesis of the polycarbosilanes, the starting materials may be produced from common organo silane compounds or from polysilane as a starting material by heating an admixture of polysilane with polyborosiloxane in an inert atmosphere to thereby produce the corresponding polymer or by heating an admixture of polysilane with a low molecular weight carbosilane in an inert atmosphere to thereby produce the corresponding polymer or by heating an admixture of polysilane with a low molecular carbosilane in an inert atmosphere and in the presence of a catalyst such as polyborodiphenylsiloxane to thereby produce the corresponding polymer. Polycarbosilanes may also be synthesized by Grignard Reaction reported in U.S. Pat. No. 5,153,295 hereby incorporated by reference.

By combining the preferred polycarbosilanes with the thermosetting component (a) or polymer and subjecting the composition to thermal or a high energy source, the resulting compositions have superior adhesion characteristics throughout the entire polymer so as to ensure affinity to any contacted surface of the coating. Present polycarbosilane also improves striation control, viscosity, and film uniformity. Visual inspection confirms the presence of improved striation control.

The present compositions may also comprise additional components such as additional adhesion promoters, antifoam agents, detergents, flame retardants, pigments, plasticizers, stabilizers, and surfactants.

Utility:

The present composition of thermosetting component (a) and adhesion promoter (b) may be combined with other specific additives to obtain specific results. Representative of such additives are metal-containing compounds such as magnetic particles, for example, barium ferrite, iron oxide, optionally in a mixture with cobalt, or other metal containing particles for use in magnetic media, optical media, or other recording media; conductive particles such as metal or carbon for use as conductive sealants; conductive adhesives; conductive coatings; electromagnetic interference (EMI)/radio frequency interference (RFI) shielding coating; static dissipation; and electrical contacts. When using these additives, the present compositions may act as a binder. The present compositions may also be employed as protection against manufacturing, storage, or use environment such as coatings to impart surface passivation to metals, semiconductors, capacitors, inductors, conductors, solar cells, glass and glass fibers, quartz, and quartz fibers.

The present compositions of thermosetting component (a) and adhesion promoter (b) are also useful in seals and gaskets, preferably as a layer of a seal or gasket, for example around a scrim, also alone. In addition, the composition is useful in anti-fouling coatings on such objects as boat parts; electrical switch enclosures; bathtubs and shower coatings; in mildew resistant coatings; or to impart flame resistance, weather resistance, or moisture resistance to an article. Because of the range of temperature resistance of the present compositions, the present compositions may be coated on cryogenic containers, autoclaves, and ovens, as well as heat exchanges and other heated or cooled surfaces and on articles exposed to microwave radiation.

The present composition of thermosetting component (a) and adhesion promoter (b) is useful as a dielectric material. Preferably, the dielectric material has a dielectric constant k of less than 3.0.

Layers of the instant compositions of thermosetting component (a) and adhesion promoter (b) may be formed by solution techniques such as spraying, rolling, dripping, spin coating, flow coating, or casting, with spin coating being preferred for microelectronics. Preferably, the present composition is dissolved in a solvent. Suitable solvents for use in such solutions of the present compositions include any suitable pure or mixture of organic, organometallic, or inorganic molecules that are volatized at a desired temperature. Suitable solvents include aprotic solvents, for example, cyclic ketones such as cyclopentanone, cyclohexanone, cycloheptanone, and cyclooctanone; cyclic amides such as N-alkylpyrrolidinone wherein the alkyl has from about 1 to 4 carbon atoms; and N-cyclohexylpyrrolidinone and mixtures thereof. A wide variety of other organic solvents may be used herein insofar as they are able to aid dissolution of the adhesion promoter and at the same time effectively control the viscosity of the resulting solution as a coating solution. Various facilitating measures such as stirring and/or heating may be used to aid in the dissolution. Other suitable solvents include methyethylketone, methylisobutylketone, dibutyl ether, cyclic dimethylpolysiloxanes, butyrolactone, γ-butyrolactone, 2-heptanone, ethyl 3-ethoxypropionate, polyethylene glycol methyl ether, propylene glycol methyl ether acetate, mesitylene, anisole, and hydrocarbon solvents such as xylenes, benzene, and toluene. Preferred solvent is cyclohexanone. Typically, layer thicknesses are between 0.1 to about 15 microns. As a dielectric interlayer for microelectronics, the layer thickness is generally less than 2 microns.

Preferably, the composition of thermosetting component (a) and adhesion promoter (b) and solvent is treated at a temperature from about 30° C. to about 350° C. for about 0.5 to about 60 hours. This treatment generally forms an oligomer of the thermosetting component (a) and adhesion promoter (b) as evidenced by GPC.

The present composition may be used in electrical devices and more specifically, as an interlayer dielectric in an interconnect associated with a single integrated circuit (“IC”) chip. An integrated circuit chip typically has on its surface a plurality of layers of the present composition and multiple layers of metal conductors. It may also include regions of the present composition between discrete metal conductors or regions of conductor in the same layer or level of an integrated circuit.

In application of the instant polymers to ICs, a solution of the present composition is applied to a semiconductor wafer using conventional wet coating processes such as, for example, spin coating; other well known coating techniques such as spray coating or flow coating may be employed in specific cases. As an illustration, a cyclohexanone solution of the present composition is spin-coated onto a substrate having electrically conductive components fabricated therein and the coated substrate is then subjected to thermal processing. An exemplary formulation of the instant composition is prepared by dissolving the present composition in cyclohexanone solvent under ambient conditions with strict adherence to a clean-handling protocol to prevent trace metal contamination in any conventional apparatus having a non-metallic lining. The resulting solution comprises based on the total solution weight, from preferably about 1 to about 50 weight percent of thermosetting component (a) and adhesion promoter (b) and about 50 to about 99 weight percent solvent and more preferably from about 3 to about 20 weight percent of thermosetting component (a) and adhesion promoter (b) and about 80 to about 97 weight percent solvent.

An illustration of the use of the present invention follows. Application of the instant compositions to form a layer onto planar or topographical surfaces or substrates may be carried out by using any conventional apparatus, preferably a spin coater, because the compositions used herein have a controlled viscosity suitable for such a coater. Evaporation of the solvent by any suitable means, such as simple air drying during spin coating, by exposure to an ambient environment, or by heating on a hot plate up to 350° C., may be employed. The substrate may have at least two layers of the present composition of thermosetting component (a) and adhesion promoter (b).

Substrates contemplated herein may comprise any desirable substantially solid material. Particularly desirable substrate layers comprise films, glass, ceramic, plastic, metal or coated metal, or composite material. In preferred embodiments, the substrate comprises a silicon or gallium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and its oxides), a polymer-based packaging or board interface such as found in a polyimide-based flex package, lead or other metal alloy solder ball surface, glass and polymers. In more preferred embodiments, the substrate comprises a material common in the packaging and circuit board industries such as silicon, copper, glass, and polymers. The present compositions may also be used as a dielectric substrate material in microchips, multichip modules, laminated circuit boards, or printed wiring boards. The circuit board made up of the present composition will have mounted on its surface patterns for various electrical conductor circuits. The circuit board may include various reinforcements, such as woven non-conducting fibers or glass cloth. Such circuit boards may be single sided, as well as double sided.

Layers made from the present compositions possess a low dielectric constant, high thermal stability, high mechanical strength, and excellent adhesion to electronic substrate surfaces including silicon, silicon nitride, silicon oxide, silicon oxycarbide, silicon dioxide, silicon carbide, silicon oxynitride, titanium nitride, tantalum nitride, tungsten nitride, aluminum, copper, tantalum, organosiloxanes, organo silicon glass, and fluorinated silicon glass. Because the adhesion promoter is molecularly dispersed, these layers demonstrate excellent adhesion to all affixed surfaces including underlying substrates and overlaid capping or masking layers, such as SiO₂ and Si₃N₄ capping layers. The use of these layers eliminates the need for an additional process step in the form of at least one primer coating application to achieve adhesion of the film to a substrate and/or overlaid surface.

After application of the present composition to an electronic topographical substrate, the coated structure is subjected to a bake and cure thermal process at increasing temperatures ranging from about 50° C. up to about 450° C. to polymerize the coating. The curing temperature is at least about 300° C. because a lower temperature is insufficient to complete the reaction herein. Generally, it is preferred that curing is carried out at temperatures of from about 375° C. to about 425° C. Curing may be carried out in a conventional curing chamber such as an electric furnace, hot plate, and the like and is generally performed in an inert (non-oxidizing) atmosphere (nitrogen) in the curing chamber. Any non oxidizing or reducing atmospheres (e.g., argon, helium, hydrogen, and nitrogen processing gases) may be used in the practice of the present invention, if they are effective to conduct curing of the present organosilicon-modified thermosetting component (a) or polymer to achieve the low k dielectric layer herein.

While not to be construed as limiting, it is speculated that the thermal processing of the present low dielectric constant composition results in a crosslinked network of thermosetting component (a) and adhesion promoter (b). In essence, the instant thermal processing of the present composition causes the silane portions of the preferred polycarbosilane adhesion promoter (b) to convert to silylene/silyl radicals which then react with both the unsaturated structures of thermosetting component (a) and the substrate surfaces, thereby creating a chemically bonded adherent interface for the dominant thermosetting monomer (a) precursor with these silylene/silyl radicals being available throughout the composition to act as attachment sources to fasten and secure any interface surface of contact by chemical bonding therewith. This reaction may also occur during formulation or treatment prior to layer formation. As already indicated, this dispersion of radicals throughout the composition accounts for the superb adhesion of the instant layers to both underlying substrate surfaces as well as overlayered surface structures such as cap or masking layers. Crucial to the materials discovered herein are the findings that the preferred formula I polycarbosilanes adhesion promoters have a reactive hydrido substituted silicon in the backbone structure of the polycarbosilane. This feature of the polycarbosilane enables it to: (1) be reactive with thermosetting component (a) and; (2) generate a polycarbosilane-modified thermosetting component (a) which possesses improved adhesion performance.

The resulting layer has a low dielectric constant k defined herein as being 3.0 or less. These layers demonstrate good adhesion to flat or topographical semiconductor surfaces or substrates.

As indicated earlier, the present polycarbosilane-modified thermosetting component (a) or polymer coating may act as an interlayer and be covered by other coatings, such as other dielectric (SiO₂) coatings, SiO₂ modified ceramic oxide layers, silicon containing coatings, silicon carbon containing coatings, silicon nitrogen containing coatings, silicon-nitrogen-carbon containing coatings, diamond like carbon coatings, titanium nitride, tantalum nitride, tungsten nitride, aluminum, copper, tantalum, organosiloxanes, organo silicon glass, and fluorinated silicon glass. Such multilayer coatings are taught in U.S. Pat. No. 4,973,526, which is incorporated herein by reference. And, as amply demonstrated, the present polycarbosilane-modified thermosetting component (a) prepared in the instant process may be readily formed as interlined dielectric layers between adjacent conductor paths on fabricated electronic or semiconductor substrates.

The present films may be used in copper dual damascene processing or substractive metal (such as aluminum) processing for integrated circuit manufacturing. The present composition may be used in a desirable all spin-on stacked film as taught by Michael E. Thomas, “Spin-On Stacked Films for Low k_{eff} Dielectrics”, Solid State Technology (July 2001), incorporated herein in its entirety by reference.

### EXAMPLES

Analytical Test Methods:

Proton NMR: A 2-5 mg sample of the material to be analyzed was put into an NMR tube. About 0.7 ml deuterated chloroform was added. The mixture was shaken by hand to dissolve the material. The sample was then analyzed using a Varian 400 MHz NMR.

High Performance Liquid Chromatography (HPLC): A HPLC with a Phenomenex luna Phenyl-Hexyl 250×4.6 mm 5 micron column was used. The column temperature was set at 40° C. Water and acetonitrile were used to improve peak separation.

| TIME | WATER | ACETONITRILE |
|---|---|---|
| Initial | 20% | 80% |
| 10 minutes | 0% | 100% |
| 30 minutes | 0% | 100% |

The following experimental conditions were used:

| | |
|---|---|
| INJECTION VOLUME | 10 microliters |
| DETECTION | UV at 200 nm |
| STOP TIME | 30 minutes |
| POST TIME | 5 minutes |

The samples were prepared as follows.

For a mixture of the halogenated intermediate such as the mixture of 1,3,5,7-tetrakis(3/4-bromophenyl)adamantane and 1,3/4-bis[1′,3′,5′-tris(3″/4″-bromophenyl]adamantyl]benzene of Example 5, the reaction mixture (0.5-1 milliliter) was shaken with approximately 4% HCl (several milliliters). The organic layer was shaken with water. An organic layer sample (twenty microliters) was taken and added to acetonitrile (one milliliter).

For a mixture of the final product such as the mixture of 1,3,5,7-tetrakis[3′/4′-(phenylethynyl)phenyl]adamantane and 1,3/4-bis{1′,3′,5′-tris[3″/4″-(phenylethynyl)phenyl]adamantyl}benzene of Example 5, the reaction mixture (0.5 gram) was mixed with chloroform (five milliliters) and 3-5% HCl (5 milliliters) and shaken. The organic layer was washed by water. An organic layer sample (100 microliters) was added to tetrahydrofuran (0.9 milliliter).

Gel Permeation Chromatography (GPC): The GPC analysis was done with Waters liquid chromatography system composed from Water 717 plus Autosampler, Waters in-line degasser, Waters 515 HPLC pump, Waters 410 Differential Refractometer (RI detector), and two columns: HP PI gel 5μ MIXED D. The analysis conditions were:

| Mobile Phase | Tetrahydrofuran (THF) |
|---|---|
| Column flow (milliliters/min) | 1.0 |
| Column temperature (° C.) | 40.0 |
| Detection | Refractive Index, Polarity negative |
| Analysis run time | 25 min |
| Injection quantity (μL) | 50 |

The sample (10 milligrams) was prepared by adding to tetrahydrofuran (one milliliter).

Mass Spectroscopy (MS): This analysis was performed on a Finnigan/MAT TSQ7000 triple stage quadrupole mass spectrometer system, with an Atmospheric Pressure Ionization (API) interface unit, using a Hewlett-Packard Series 1050 HPLC system as the chromatographic inlet. Both mass spectral ion current and variable single wavelength UV data were acquired for time-intensity chromatograms.

Chromatography was conducted on a Phenomenex Luna 5 micron phenyhexyl column (250×4.6 mm). Sample auto-injections were generally 10 or 20 microliters of concentrated solutions, both in tetrahydrofuran and without tetrahydrofuran. The mobile phase flow through the column was 1.0 microliter/minute of acetonitrile/water, initially 70/30 for 5 minutes then programmed to 100% acetonitrile at 15 minutes and held until 100 minutes (longer than actually necessary to thoroughly elute material from the column). Atmospheric Pressure Chemical Ionization (APCI) mass spectra were recorded alternately in both positive and negative ion modes. The APCI corona discharge was 5 microA, about 5 kV for positive ionization, and about 4 kV for negative ionization. The heated capillary line was maintained at 200° C. and the vaporizer cell at 400° C. The on detection system after quadrupole mass analysis was set at 15 kV conversion dynode and 1500 V electron multiplier voltage. Mass spectra were typically scanned at 0.5 sec/scan from about m/z 150 to 2000 a.m.u. for positive ionization and m/z 125 to 2000 a.m.u. for negative ionization modes.

Differential Scanning Calorimetry (DSC): DSC measurements were performed using a TA Instruments 2920 Differential Scanning Calorimeter in conjunction with a controller and associated software. A standard DSC cell with temperature ranges from 250° C. to 725° C. (inert atmosphere: 50 ml/min of nitrogen) was used for the analysis. Liquid nitrogen was used as a cooling gas source. A small amount of sample (10-12 mg) was carefully weighed into an Auto DSC aluminum sample pan (Part #990999-901) using a Mettler Toledo Analytical balance with an accuracy of ±0.0001 grams. Sample was encapsulated by covering the pan with the lid that was previously punctured in the center to allow for outgasing. Sample was heated under nitrogen from 0° C. to 450° C. at a rate of 100° C./minute (cycle 1), then cooled to 0° C. at a rate of 100° C./minute. A second cycle was run immediately from 0° C. to 450° C. at a rate of 100° C./minute (repeat of cycle 1). The cross-linking temperature was determined from the first cycle.

FTIR analysis: FTIR spectra were taken using a Nicolet Magna 550 FTIR spectrometer in transmission mode. Substrate background spectra were taken on uncoated substrates. Film spectra were taken using the substrate as background. Film spectra were then analyzed for change in peak location and intensity.

Dielectric Constant: The dielectric constant was determined by coating a thin film of aluminum on the cured layer and then doing a capacitance-voltage measurement at 1 MHz and calculating the k value based on the layer thickness.

Glass Transition Temperature (Tg): The glass transition temperature of a thin film was determined by measuring the thin film stress as a function of temperature. The thin film stress measurement was performed on a KLA 3220 Flexus. Before the film measurement, the uncoated wafer was annealed at 500° C. for 60 minutes to avoid any errors due to stress relaxation in the wafer itself. The wafer was then deposited with the material to be tested and processed through all required process steps. The wafer was then placed in the stress gauge, which measured the wafer bow as function of temperature. The instrument calculated the stress versus temperature graph, provided that the wafer thickness and the film thickness were known. The result was displayed in graphic form. To determine the Tg value, a horizontal tangent line was drawn (a slope value of zero on the stress vs. temperature graph). Tg value was where the graph and the horizontal tangent line intersect. It should be reported if the Tg was determined after the first temperature cycle or a subsequent cycle where the maximum temperature was used because the measurement process itself may influence Tg.

Isothermal Gravimetric Analysis (ITGA) Weight Loss: Total weight loss was determined on the TA Instruments 2950 Thermogravimetric Analyzer (TGA) used in conjunction with a TA Instruments thermal analysis controller and associated software. A Platinel II Thermocouple and a Standard Furnace with a temperature range of 25° C. to 1000° C. and heating rate of 0.1° C. to 100° C./min were used. A small amount of sample (7 to 12 mg) was weighed on the TGA's balance (resolution: 0.1 g; accuracy: to ±0.1%) and heated on a platinum pan. Samples were heated under nitrogen with a purge rate of 100 ml/min (60 ml/min going to the furnace and 40 ml/min to the balance). Sample was equilibrated under nitrogen at 20° C. for 20 minutes, then temperature was raised to 200° C. at a rate of 10° C./minute and held at 200° C. for 10 minutes. Temperature was then ramped to 425° C. at a rate of 10° C./minute and held at 425° C. for 4 hours. The weight loss at 425° C. for the 4 hour period was calculated.

Shrinkage: Film shrinkage was measured by determining the film thickness before and after the process. Shrinkage was expressed in percent of the original film thickness. Shrinkage was positive if the film thickness decreased. The actual thickness measurements were performed optically using a J. A. Woollam M-88 spectroscopic ellipsometer. A Cauchy model was used to calculate the best fit for Psi and Delta (details on Ellipsometry can be found in e.g. “Spectroscopic Ellipsometry and Reflectometry” by H. G. Thompkins and William A. McGahan, John Wiley and Sons, Inc., 1999).

Refractive Index: The refractive index measurements were performed together with the thickness measurements using a J. A. Woollam M-88 spectroscopic ellipsometer. A Cauchy model was used to calculate the best fit for Psi and Delta. Unless noted otherwise, the refractive index was reported at a wavelenth of 633 nm (details on Ellipsometry can be found in e.g. “Spectroscopic Ellipsometry and Reflectometry” by H. G. Thompkins and William A. McGahan, John Wiley and Sons, Inc., 1999).

Modulus and Hardness: Modulus and hardness were measured using instrumented indentation testing. The measurements were performed using a MTS Nanoindenter XP (MTS Systems Corp., Oak Ridge, Tenn.). Specifically, the continuous stiffness measurement method was used, which enabled the accurate and continuous determination of modulus and hardness rather than measurement of a discrete value from the unloading curves. The system was calibrated using fused silica with a nominal modulus of 72±3.5 GPa. The modulus for fused silica was obtained from average value between 500 to 1000 nm indentation depth. For the thin films, the modulus and hardness values were obtained from the minimum of the modulus versus depth curve, which is typically between 5 to 15% of the film thickness.

Tape Test: The tape test was performed following the guidelines given in ASTM D3359-95. A grid was scribed into the dielectric layer according to the following. A tape test was performed across the grid marking in the following manner: (1) a piece of adhesive tape, preferably Scotch brand #3m600-1/2X1296, was placed on the present layer, and pressed down firmly to make good contact; and (2) the tape was then pulled off rapidly and evenly at an angle of 180° to the layer surface. The sample was considered to pass if the layer remained intact on the wafer, or to have failed if part or all of the film pulled up with the tape.

Stud Pull Test: Epoxy-coated studs were attached to the surface of a wafer containing the layers of the present invention. A ceramic backing plate was applied to the back side of the wafer to prevent substrate bending and undue stress concentration at the edges of the stud. The studs were then pulled in a direction normal to the wafer surface by a testing apparatus employing standard pull protocol steps. The stress applied at the point of failure and the interface location were then recorded.

Compatibility with Solvents: Compatibility with solvents was determined by measuring film thickness, refractive index, FTIR spectra, and dielectric constant before and after solvent treatment. For a compatible solvent, no significant change should be observed.

### EXAMPLE 1

### Synthesis of 4,6-bis(adamantyl)resorcinol

Into a 250-mL 3-neck flask, equipped with nitrogen inlet, thermocouple and condenser, were added resorcinol (11.00 g, 100.0 mMol), bromoadamantane (44.02 g, 205.1 mMol) and toluene (150 mL). The mixture was heated to 110° C. and became a clear solution. The reaction was allowed to continue for 48 h, at which time TLC showed that all the resorcinol had disappeared. The solvent was removed and the solid was crystallized from hexanes (150 mL). The disubstituted product was obtained in 66.8% yield (25.26 g) as a white solid. Another 5.10 g product was obtained by silica gel column chromatography of the concentrated mother liquor after the first crop. The total yield of the product was 80.3%. Characterization of the product was by proton NMR, HPLC, FTIR, and MS.

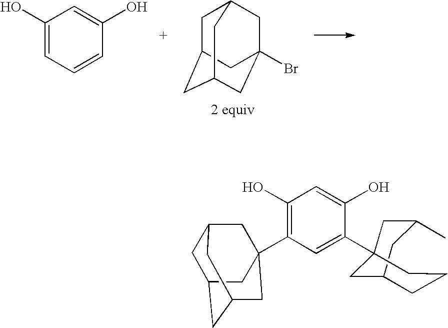

### Polymerization of 4,6-bis(adamantyl)resorcinol into a poly(arylene ether) Backbone

In a 250-mL 3-neck flask, equipped with a nitrogen inlet, thermocouple and Dean-Stark trap, were added bis(adamantyl)resorcinol (7.024 g, 18.57 mMol), FBZT (5.907 g, 18.57 mMol), potassium carbonate (5.203 g, 36.89 mMol), DMAC (50 mL), and toluene (25 mL). The reaction mixture was heated to 135° C. to produce a clear solution. The reaction was continued for 1 h at this temperature and the temperature was raised to 165° C. by removing some of the toluene. The course of polymerization was monitored by GPC. At M_{w}=22,000, the reaction was stopped. Another 50-mL portion of DMAC was added to the reaction flask. The solid was filtered at room temperature, and was extracted with hot dichloromethane (2×150 mL). Methanol (150 mL) was added to the solution to precipitate a white solid, which was isolated by filtration. The yield was 65.8% (8.511 g). The solid was dissolved in tetrahydrofuran (150 mL) and methanol (300 mL) was added to the solution slowly. The precipitated white solid was isolated by filtration and dried in vacuo at 90° C.

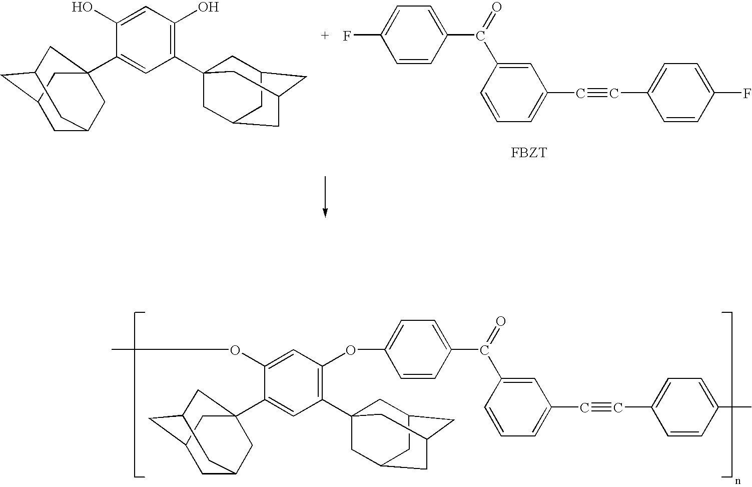

### EXAMPLE 1A

A composition is formed from the product of Example 1, silane adhesion promoter, and solvent and then spun onto a substrate.

### EXAMPLE 2

### Synthesis of Alternative Polymers

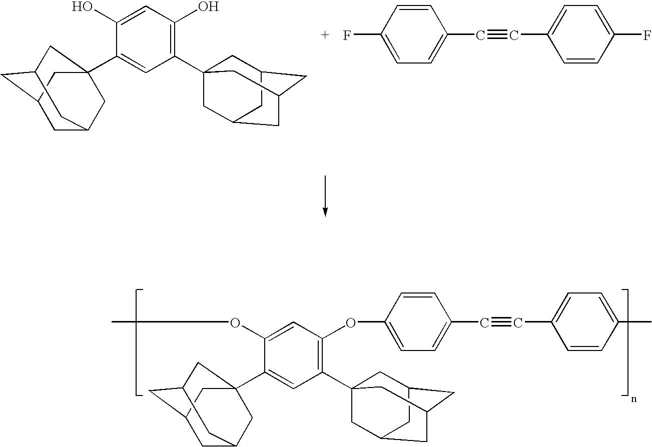

The synthetic procedure as described in Example 1 was used except that 4,4′-difluorotolane was used as the difluoro compound.

### EXAMPLE 2A

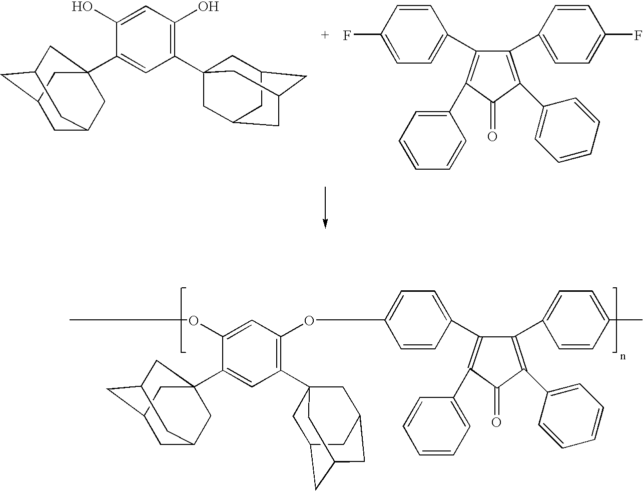

The synthetic procedure of Example 1 is followed except that 3,4-difluorotetraphenylcyclodienone is used as the difluoro compound.

### EXAMPLE 2B

A composition is formed from the product of Example 2, phenol-formaldehyde resin adhesion promoter, and solvent and then spun onto a substrate.

### EXAMPLE 2C

A composition is formed from the product of Example 2A, glycidyl ether adhesion promoter, and solvent and then spun onto a substrate.

### EXAMPLE 3

Contemplated Alternative Backbones

The following structures are contemplated exemplary backbones that can be fabricated according to the general synthetic procedure in Examples 1 and 2.

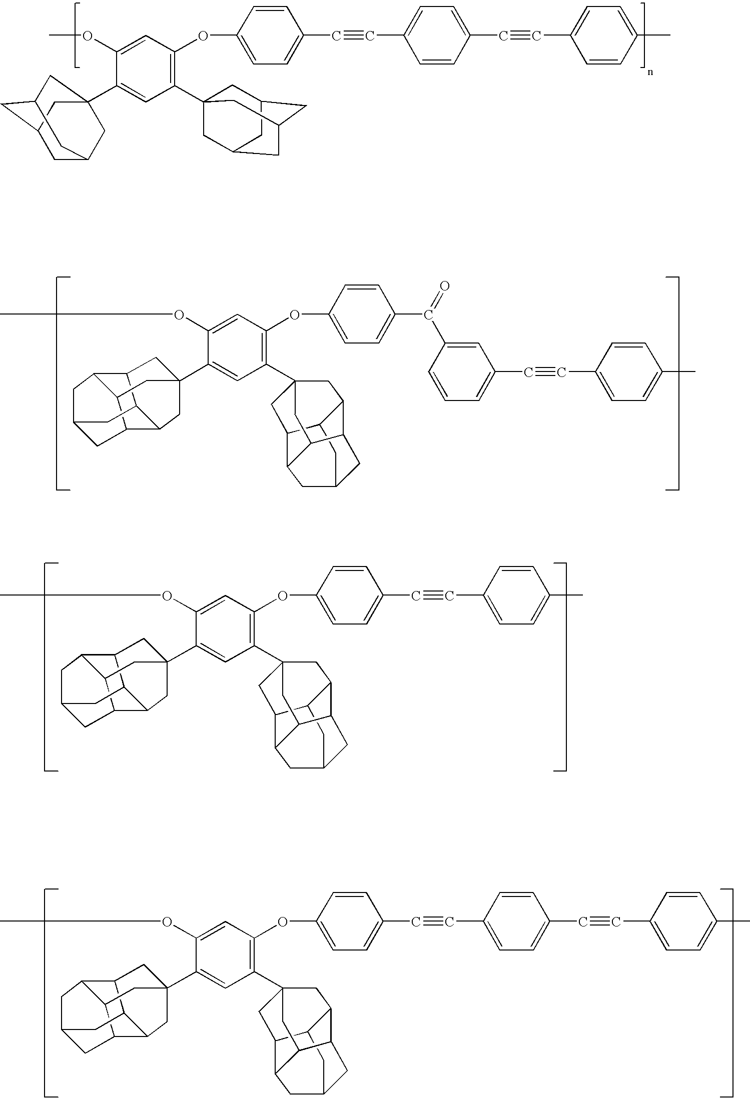

### EXAMPLE 3A

The composition is formed from the first polymer of Example 3, unsaturated carboxylic acid ester adhesion promoter, and solvent and then spun onto a substrate.

### EXAMPLE 3B

The composition is formed from the second polymer of Example 3, vinyl pyridine oligomer or polymer adhesion promoter, and solvent and then spun onto a substrate.

### EXAMPLE 3C

The composition is formed from the third polymer of Example 3, vinyl aromatic oligomer or polymer adhesion promoter, and solvent and then spun onto a substrate.

### EXAMPLE 3D

The composition is formed from the fourth polymer of Example 3, vinyl heteroaromatic oligomer or polymer adhesion promoter, and solvent and then spun onto a substrate.

### EXAMPLE 4

Adamantanyl endcapped monomers as shown in FIGS. 9A and 9B were synthesized as described in C. M. Lewis, L. J. Mathias, N. Wiegal, ACS Polymer Preprints, 36(2), 140 (1995).

### EXAMPLE 4A

A composition is formed from the product of Example 4, vinyl silane adhesion promoter, and solvent and then spun onto a substrate.

### EXAMPLE 5

This example illustrates the preparation of a thermosetting component (a).

### Step 1: Synthesis of 1,3,5,7-Tetrabromoadamantane (TBA)

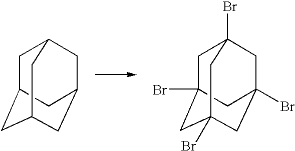

1,3,5,7-Tetrabromoadamantane synthesis started from commercially available adamantane and followed the synthetic procedures as described in G. P. Sollott and E. E. Gilbert, J. Org. Chem., 45, 5405-5408 (1980), B. Schartel, V. Stümpflin, J. Wendling, J. H. Wendorff, W. Heitz, and R. Neuhaus, Colloid Polym. Sci., 274, 911-919 (1996), or A. P. Khardin, I. A. Novakov, and S. S. Radchenko, Zh. Org. Chem., 9, 435 (1972). Quantities of up to 150 g per batch were routinely synthesized.

### Step 2: Synthesis of Mixture of 1,3,5,7-Tetrakis(3/4-bromophenyl)adamantane (TBPA) and 1,3/4-bis[1′,3′,5′-tris(3″/4″-bromophenyl]adamantyl]benzene (BTBPAB)

In a first step, TBA was reacted with bromobenzene to yield supposedly 1,3,5,7-tetrakis(3/4bromophenyl)adamantane (TBPA) as described in Macromolecules, 27, 7015-7023 (1994) (supra). HPLC-MS analysis showed that of the total reaction product the percentage of the desired TBPA present was approximately 50%, accompanied by 40% of the tribrominated tetraphenyladamantane, and about 10% of the dibrominated tetraphenyladamantane.

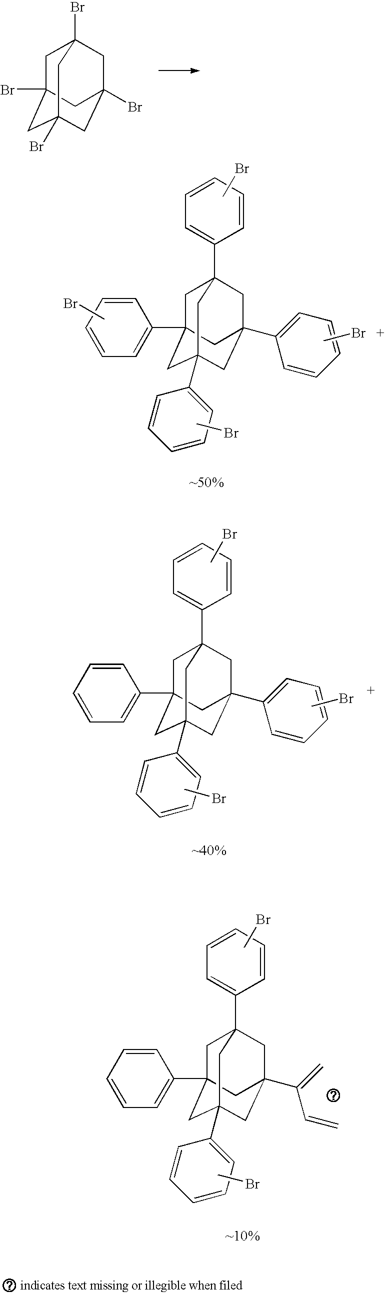

Specifically, the experimental procedure for Step 2 above follows: A dry 5 L 3-neck round bottom flask, water condenser, magnetic stir-bar, heating mantle, thermocouple, thermal controller unit, and N₂ inlet-outlet to 30% KOH solution were assembled. The flask was purged with N₂ for 10 min. 2 L (62% v/v from total volume) of bromobenzene were poured into the flask and the stir-bar was activated. TBA (160.00±0.30 g) was added and the funnel was rinsed with 1 L (31 % v/v from total volume) of bromobenzene. An HPLC sample of starting material was taken and compared with standard HPLC chromatogram. Aluminum bromide (32.25±0.30 g) was added to the solution and the funnel was rinsed with 220 mL (7% v/v from total volume) of bromobenzene. Solution at this point was dark purple with no precipitation visible. The reaction mixture was stirred for 1 hour at room temperature. After 1 hour, the reaction mixture temperature was raised to 40° C. After temperature reached 40° C., the reaction mixture was stirred for 3 hours. An HPLC sample was taken at time 1+3.0, respectively, at 40° C. The reaction was over when no traces of TBA were seen on HPLC chromatogram. When the reaction was over, the dark reaction mixture was poured into a 20 L reactor containing 7 L (217% v/v relative to the total volume of bromobenzene) deionized water, 2 L (62% v/v relative to the total volume of bromobenzene) ice, and 300 mL (37%) HCl (9% v/v relative to the total volume of bromobenzene). The reaction mixture was stirred vigorously using an overhead-stirrer for 1 hr±10 min.

The organic layer was transferred to a separatory chamber and washed twice with 700 mL (22% v/v relative to the total volume of bromobenzene) portions of de-ionized water. The washed organic layer was placed in a 4 L separatory funnel and added, as a slow stream, to 16 L (5× times to the total volume of bromobenzene) methanol, in a 30 L reactor placed under an overhead-stirrer, to precipitate a solid during 25 min±5 min. After the addition was complete, the methanol suspension was agitated vigorously for 1 hr±10 min. The methanol suspension was filtered by suction through a Buchner funnel (185 mm). The solid was washed on filter cake with three portions of 600 mL (19% v/v relative to the total volume of bromobenzene) methanol. The solid was suctioned dry for 30 min.

The resulting pinkish powder was emptied into a crystallizer dish using a spatula and placed in a vacuum-oven to dry overnight and then weighed after drying. The powder was re-dried in the vacuum-oven for 2 additional hours until the weight change was <1% and re-weighed. After solid was dried, the final weight was recorded and the yield was calculated. The product was as described above of approximately 50% TBPA, 40% tribrominated tetraphenyladamantane, and 10% dibrominated tetraphenyladamantane. The yield was 176.75 grams. 3-5 weight percent of BTBPAB formed.

### Step 3: Synthesis of TBPA and BTBPAB

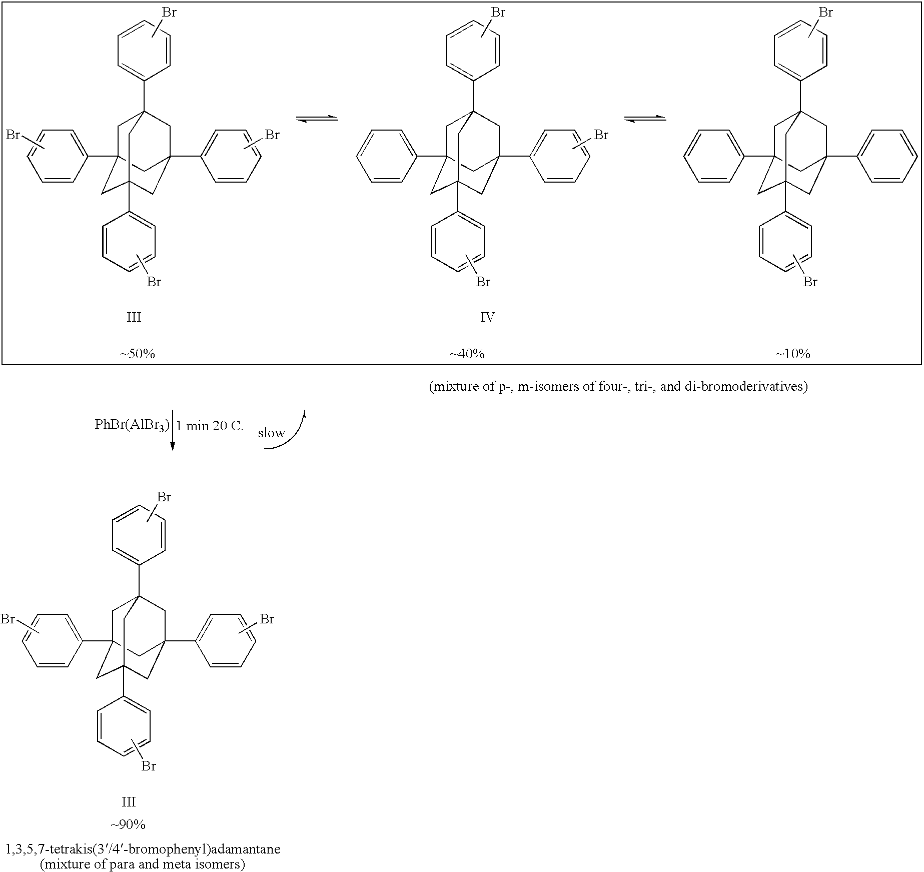

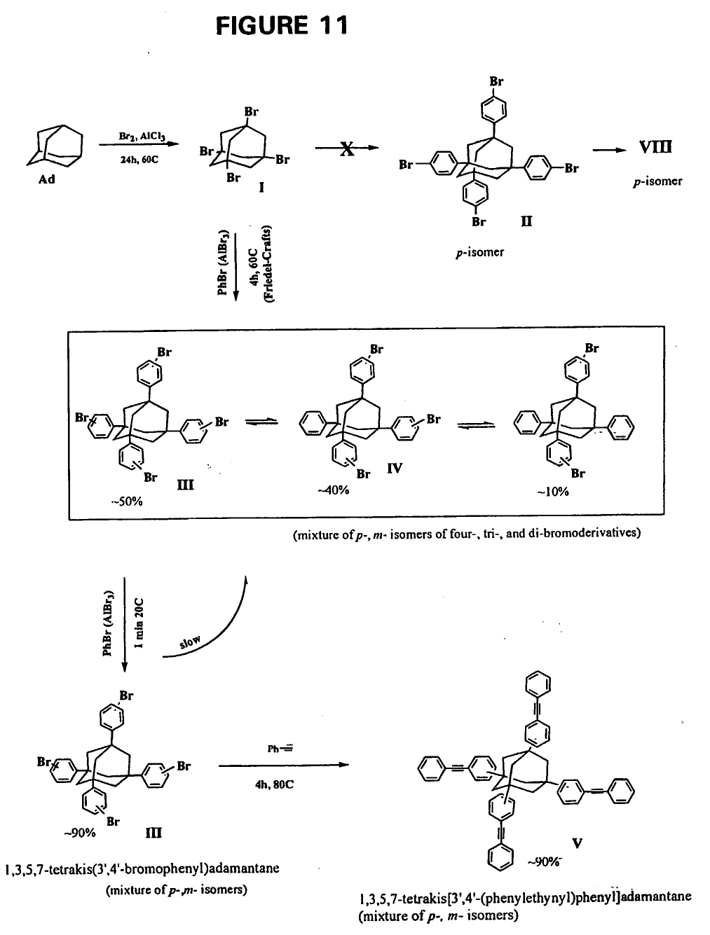

Unexpectedly, however, when the preceding product mixture was subjected to fresh reagent and catalyst (bromobenzene and AlCl₃, 1 min at 20° C.), the TBPA proportion of the mixture of the tetrabrominated, tribrominated, and dibrominated monomers increased from about 50% to approximately 90-95%. 3-5 weight percent of BTBPAB remained. We were so surprised by this result that we repeated it several times to confirm and this resulted in a novel process for converting the preceding mixture to a thermosetting component (a), as described below and in FIG. 11.

Specifically, the experimental procedure for Step 3 above follows. The equipment used was the same as that of Step 2 above.

The corresponding amounts of bromobenzene and aluminum bromide needed were calculated based on the yield of the TBPA synthesized in the above/conventional synthesis. The appropriate amount (80% v/v from the total volume) of bromobenzene was poured into the flask and the stir-bar was activated. The full amount of TBPA from the Step 2 synthesis above was added and the funnel was rinsed with appropriate amount (10% v/v from the total volume) of bromobenzene. An HPLC sample of starting material was taken and compared with standard HPLC chromatogram. The full amount of aluminum bromide was added to the solution and the funnel was rinsed with remainder (10% from the total volume) of bromobenzene. The solution at this point was dark purple with no precipitation visible. The reaction mixture was stirred for 17 min at room temperature. An HPLC sample was taken after 5 min and after 17 min. The reaction was over when the group of peaks corresponding to TBPA was dominant in the HPLC chromatogram. When the reaction was over, the dark reaction mixture was poured into a 20 L reactor containing 7 L (217% v/v relative to the total volume of bromobenzene) deionized water, 2 L (62% v/v relative to the total volume of bromobenzene) ice, and 300 mL (37%) HCl (9% v/v relative to the total volume of bromobenzene), and stirred vigorously using an overhead-stirrer for 1 hr±10 min.

The organic layer was transferred to a separatory funnel and washed twice with 700 mL (22% v/v to the total volume of bromobenzene) portions of deionized water and 3 times with 700 mL (22% v/v relative to the total volume of bromobenzene) portions of saturated NaCl solution. The washed organic layer was placed in a 4 L separatory funnel and added, as a slow stream, to the appropriate amount (5× times to the total volume of bromobenzene) methanol, in a 30 L reactor placed under an overhead-stirrer, to precipitate a solid for 25min±5min. After addition was complete, the methanol suspension was agitated vigorously for 1 hr±10 min. The methanol suspension was filtered by suction through a Buchner funnel (185mm). The solid was washed on filter cake with three portions of 600 mL (19% v/v relative to the total amount of bromobenzene) methanol. The solid was suctioned dry for 30 min.

The resulting pinkish powder was emptied into a crystallizer dish using a spatula, placed in an oven to dry overnight, weighed after drying, and re-dried in the vacuum-oven for 2 additional hours, until the weight change was <1%, and re-weighed. After the solid was dried, the final weight was recorded and the yield was calculated. The yield was 85%.

### Step 4: Synthesis of Mixture of 1,3,5,7-tetrakis[3′/4′-(phenylethynyl)phenyl]adamantane (TPEPA) and 1,3/4-bis{1′,3′,5′-tris[3″/4″-(phenylethynyl)phenyl]adamantyl}benzene (BTPEPAB)

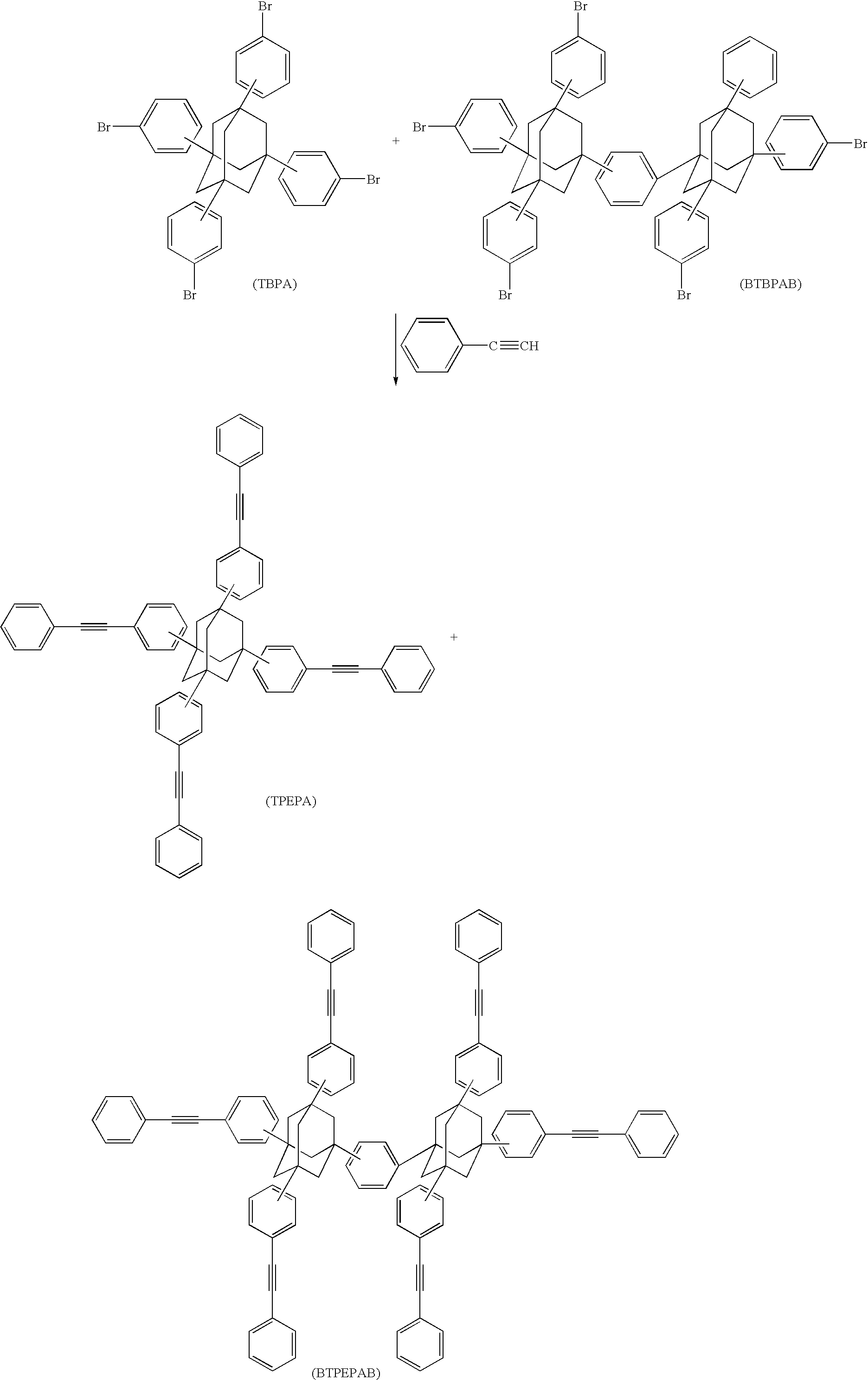

A mixture of TBPA and BTBPAB was reacted with phenylacetylene to yield the final product of 95-97 weight percent 1,3,5,7-tetrakis[3′/4′-(phenylethynyl)phenyl[adamantane (TPEPA)—as a mixture of isomers—following a general reaction protocol for a palladium-catalyzed Heck ethynylation and 3-5 weight percent 1, 3/4-bis{1′,3′,5′-tris[3″/4″-(phenylethynyl)phenyl]adamantyl}benzene (BTPEPAB) as a mixture of meta- and para-isomers as identified by GPC, NMR, and HPLC. The mixture of TPEPA and BTPEPAB made from the reaction including TBPA is soluble in cyclohexanone.

Specifically, the experimental procedure for this Step 4 synthesis follows. The following equipment was assembled: dry 2 L 3-neck round bottom flask, water condenser, overhead-stirrer, heating mantle, thermocouple, thermal controller unit, dropping funnel, 2-necked adapter, and N₂ inlet-outlet to 30% KOH solution. The flask was purged with N₂ for 10 min.

The mixture of TBPA and BTBPAB from the Step 3 synthesis procedure above was weighed. The triethylamine (TEA) (total calculated TEA volume minus 300 mL) was added to the reaction flask and the overhead stirrer was activated, followed by the addition of the following compounds in the order listed below: dichlorobis(triphenylphosphine)palladium[II] catalyst, rinsed the funnel with 50 mL (4% of total volume) of TEA and stirred for 5 min; triphenylphosphine, rinsed the funnel with 50 mL (4% of total volume) TEA, and stirred for 5 min; and Copper(I) Iodide, rinsed the funnel with 50 mL (4% of total volume) TEA, stirred for 5 min. The total amount of TBPA from the Step 3 synthesis above was added and rinsed the funnel with 100 mL (8% of total volume) TEA. The flask was heated to 80° C. Once the reaction mixture temperature reached 80° C., a HPLC sample was taken for analysis. This was the starting material. The measured quantity of phenylacetylene diluted with 50 mL (4% of total volume) TEA was placed in the dropping funnel, mounted on one neck of the 2-necked adapter. The diluted phenylacetylene was added dropwise to the reaction mixture over 30 min±10 min. This was an exothermic reaction. The temperature was controlled by using a water bath. The heating continued for 3 hours. The reaction was stopped after 3 hours of heating at 80° C. An HPLC sample was taken at time 3 hours at 80° C.

The reaction mixture was cooled to 50° C. and then filtered through a Buchner funnel. (185 mm). The crude solids were washed twice with 600 mL of TEA. (v/v%=52% relative to the calculated TEA volume). The filter cake was loaded to a 4 L beaker and the contents were stirred with 1 L (v/v%=87% relative to the calculated TEA volume) of TEA for 15 min at room temperature. The filter cake was filtered through a Buchner funnel (185 mm) and the crude solids were washed with 300 mL TEA (v/v%=26% relative to the calculated TEA volume). The solids were suction dried overnight. HPLC, DSC, trace metals, and UV-VIS were done on a 3 gram sample of the crude product.

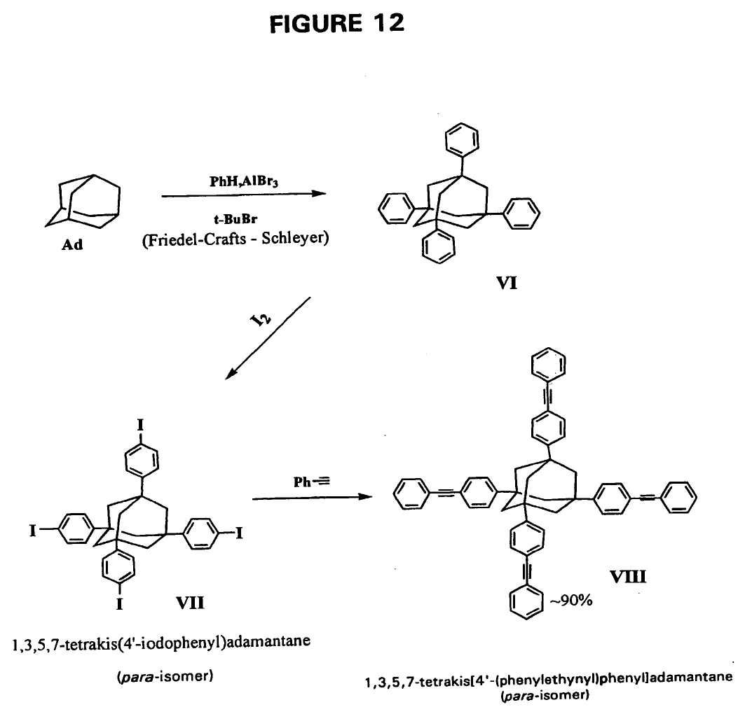

An explanation of the differences between the prior art and the present invention follows. FIGS. 11 and 12 show the preparation of the isomers discussed below, and the Roman numerals in the text of this Example correspond with the Roman numerals in FIGS. 11 and 12. As mentioned briefly in the Background section, Reichert's goal was to prepare 1,3,5,7-tetrakis[(4-phenylethynyl)phenyl)]adamantane of definite structure, namely, single p-isomer of this compound -1,3,5,7-tetrakis[4″-(phenylethynyl)phenyl]adamantane (VIII). This, and only this compound, having definite structure (which can be characterized by the analytical methods) was the target of Reichert's work.

Reichert's plan was to realize the following sequence:

1,3,5,7-tetrabromoadamantane (I)→1,3,5,7-tetrakis(4′-bromophenyl)adamantane (II) (p-isomer)→1,3,5,7-tetrakis[4′-(phenylethynyl)phenyl)]adamantane (VIII) (p-isomer)

Reichert failed on step (I)→(II) in that she thought she obtained 1,3,5,7-tetrakis(3′/4′-bromophenyl)adamantane (III)—a mixture of isomers of 1,3,5,7-tetrakis(bromophenyl)adamantane, containing the combination of p- and m-bromophenyl groups attached to adamantane core (see below), and she considered the goal of her work not fulfilled. As support for this she writes: “The lack of regioselection during arylation discouraged us from attempting further Friedel-Crafts reactions on adamantane and lead to further study of the derivatization of the easily formed 1,3,5,7-tetraphenyladamantane” (VI). To prepare single p-isomer -1,3,5,7-tetrakis[4′-(phenylethynyl)phenyl)]adamantane (VIII), she designed a “detour procedure”, as follows:

1,3,5,7-tetraphenyladamantane (VI)→1,3,5,7-tetrakis(4′-iodophenyl)adamantane (VII)→1,3,5,7-tetrakis[4′-(phenylethynyl)phenyl]adamantane (VIII)

Reichert successively realized this sequence, and isolated the single p-isomer (VII), but the solubility of this compound turned out to be so low, that she was not able to obtain ¹³C NMR spectra of this compound. Reichert observes: “Compound 3 [(VIII)]) was found to be soluble enough in chloroform that a ¹H NMR spectrum could be obtained. However, acquisition times were found impractical for obtaining a solution ¹³C NMR spectrum. Solid-state NMR was used to identify the product.” Reichert. Diss.(supra). And to confirm these results, Reichert's compound was tested with several standard organic solvents and was found to be essentially insoluble in every one of the tested organic solvents.

So, in other words, Reichert prepared what she thought was 1,3,5,7-tetrakis(3′/4′-bromophenyl)adamantane (III), but did not continue in this direction, because this product was not a single isomer with definite structure. Instead she prepared single para-isomer of 1,3,5,7-tetrakis(4′-iodophenyl)adamantane (VII), and transformed it into single isomer of 1,3,5,7-tetrakis[4′-(phenylethynyl)phenyl]adamantane (VIII), which turned out to be insoluble, and therefore not useful.

We repeated the reaction of 1,3,5,7-tetrabromoadamantane with bromobenzene numerous times and our analysis of the reaction product of 1,3,5,7-tetrabromoadamantane with bromobenzene showed that it was not 1,3,5,7-tetrakis(3′/4′-bromophenyl)adamantane (III) (as Reichert suggested), but a mixture of 1,3,5,7-tetrakis(3′/4′-bromophenyl)adamantane (III) with approximately equal quantity of 1-phenyl-3,5,7-tris(3′/4′-bromophenyl)adamantane (IV). This conclusion was confirmed by LC-MS study and elemental analysis.

We were able to find the cause of such reaction course. Bromobenzene is known to disproportionate essentially in the conditions of Friedel-Crafts reaction (G. A. Olah, W. S. Tolgyesi, R. E. A. Dear. J. Org. Chem., 27, 3441-3449 (1962)):

2 PhBr→PhH+Br₂Φ

When benzene concentration in the reaction mixture increases, it begins to replace bromine in (I) [or bromophenyl in (III)]; benzene proportion is so high, that fast established equilibria leads to approx. equal quantities of (III) and (IV).

Therefore, Reichert did not obtain (as she thought) 1,3,5,7-tetrakis(3′/4′-bromophenyl)adamantane (III); instead, she had approx. 1:1 mixture of 1,3,5,7-tetrakis(3′/4′-bromophenyl)adamantane (III) with 1-phenyl-3,5,7-tris(3′/4′-bromophenyl)adamantane (IV).

To shift equilibria toward 1,3,5,7-tetrakis(3′/4′-bromophenyl)adamantane (III) side, we treated the solid reaction product of 1,3,5,7-tetrabromoadamantane with bromobenzene [1:1 mixture of 1,3,5,7-tetrakis(3′/4′-bromophenyl)adamantane (III) and 1-phenyl-3,5,7-tris(3′/4′-bromophenyl)adamantane (IV)] by a new-portion of bromobenzene in presence of aluminum bromide. It turned out that pure bromobenzene immediately replaced phenyl group in 1-phenyl-3,5,7-tris(3′/4′-bromophenyl)adamantane (IV), so the product in solution in 30 seconds contained approximately 90-95% 1,3,5,7-tetrakis(3′/4′-bromophenyl)adamantane (III). This situation was observed for approximately 5-10 min at room temperature, after which slowly increasing concentration of benzene led to an increase of 1-phenyl-3,5,7-tris(3′/4′-bromophenyl)adamantane (IV) concentration, and in several hours equilibria was re-established with approximately equal concentration of 1,3,5,7-tetrakis(3′/4′-bromophenyl)adamantane (III) and 1-phenyl-3,5,7-tris(3′/4′-bromophenyl)adamantane (IV).

Therefore, 1,3,5,7-tetrakis(3′/4′-bromophenyl)adamantane (III) (that Reichert thought she synthesized) can be prepared by second treatment of the solid reaction product of 1,3,5,7-tetrabromoadamantane with bromobenzene in presence of aluminum bromide.

1,3,5,7-tetra(3′/4′-bromophenyl)adamantane (III) subjected to Heck reaction with phenylacetylene gave a novel mixture of 95-97 weight percent 1,3,5,7-tetra[3′/4′-(phenylethynyl)phenyl]adamantane (V) (A mixture of p- and m-isomers formed. Five isomers formed including (1) para, para, para, para-; (2) para, para, para, meta-; (3) para, para, meta, meta-; (4) para, meta, meta, meta-; and (5) meta, meta, meta, meta. Trace o-isomer may also be present.) and 3-5 weight percent 1,3/4-bis{1′,3′,5′-tris[3″/4″-phenylethynyl)phenyl]adamantyl}benzene (14 isomers formed.) which were identified by GPC, NMR, and HPLC and was very soluble in toluene, xylenes, cyclohexanone, anisole, propylene glycol methyl ether acetate, mesitylene, cyclohexylacetate, etc. For example, its solubility in cyclohexanone is >20%. This property enables it to be spin coated, which ensures practical use of this material, especially and preferably, in the field of layered materials and semiconductors.

Therefore, our prepared intermediate 1,3,5,7-tetra(3′/4′-bromophenyl)adamantane (III), gave us the opportunity to make 1,3,5,7-tetra[3′/4′-(phenylethynyl)phenyl]adamantane (V) and 1,3/4-bis{1′,3′,5′-tris[3″/4″-(phenylethynyl)phenyl]adamantyl}benzene (soluble mixture of p- and m-isomers), which is useful as a thermosetting component (a).

### EXAMPLE 6

This example illustrates the preparation of another thermosetting monomer (a).

### Step 1: Synthesis of m- and n-bromotolane isomers

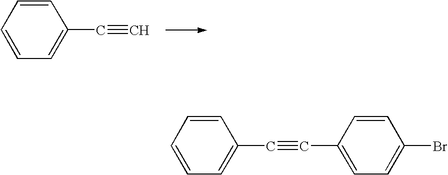

In a 500-mL 3-neck round-bottom flask, equipped with an addition funnel and a nitrogen gas inlet, 4-iodobromobenzene (25.01 g, 88.37 mmoL), triethylamine (300 mL), bis(triphenylphosphine)palladium[II] chloride (0.82 g), and copper[I] iodide (0.54 g) were added. Then, a solution of phenylacetylene (9.025 g, 88.37 mmoL) in triethylamine (50 mL) was added slowly, and the temperature of the solution was kept under 35° C. under stirring. The mixture was stirred for another 4 hours after addition was completed. The solvent was evaporated on the rotary evaporator and the residue was added to 200 mL of water. The product was extracted with dichloromethane (2×50 mL). The organic layers were combined and the solvents were removed by rotary evaporator. The residue was washed with 80 mL hexanes and filtered. HPLC showed a pure product (yield, 19.5 g, 86%). Additional purification was performed by short silica column chromatography (Eluent is 1:2 mixture of toluene and hexanes). A white crystalline solid was obtained after solvent removal. The purity of the product was characterized by GC/MS in acetone solution, and further characterized by proton NMR.

### Step 2: Synthesis of m- and p-Ethynyltolane

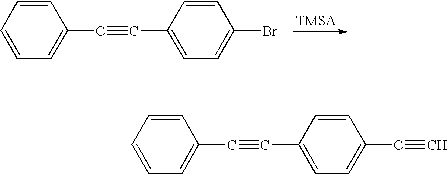

The synthesis of p-ethynyltolane from p-bromotolane was performed in two steps. In the first step, p-bromotolane was trimethylsilylethynylated using trimethylsilylacetylene (TMSA, as shown above), and in the second step, the reaction product of the first step was converted to the final end product.

Step a (Trimethylsilylethynylation of 4-bromotolane): 4-Bromotolane (10.285 g, 40.0 mMol), ethynyltrimethylsilane (5.894 g, 60.0 mMol), 0.505 g (0.73 mMol) of dichlorobis(triphenylphosphine)palladium[II] catalyst, 40 mL of anhydrous triethylamine, 0.214 g (1.12 mMol) of copper[l] iodide, and 0.378 g (1.44 mMol) of triphenylphosphine were placed into the N₂purged, 5-Liter 4-neck round-bottom flask, equipped with an overhead mechanical stirrer, condenser, and positioned inside a heating mantle. The mixture was heated to a gentle reflux (about 88° C.) and maintained at reflux for 1.5 hours. The reaction mixture became a thick black paste and was cooled. Thin-layer chromatographic analysis indicated complete conversion of starting material 4-bromotolane to a single product. The solids were filtered and washed with 50 mL of triethylamine, mixed with 400 mL of water and stirred for 30 minutes. The solids was filtered and washed with 40 mL of methanol. The crude solid was recrystallized from 500 mL of methanol. On standing, lustrous silver colored crystals settled out. They were isolated by filtration and washed with 2×50 mL of methanol. 4.662 g was recovered (42.5% yield).

Step b (Conversion of 4-(Trimethylsilyl)ethynyltolane to 4-Ethynyltolane): To a 1-Liter 3 neck round-bottom flask equipped with a nitrogen inlet, an overhead mechanical stirrer, was charged 800 mL of anhydrous methanol, 12.68 g (46.2 mMol) of 4-(trimethylsilyl)ethynyltolane, and 1.12 g of anhydrous potassium carbonate. The mixture was heated to 50° C. Stirring continued until no starting material was detected by HPLC analysis (about 3 hours). The reaction mixture was cooled. The crude solids were stirred in 40 mL of dichloromethane for 30 min and filtered. The filtered suspended solids by HPLC showed mainly impurities. The dichloromethane filtrate was dried and evaporated to yield 8.75 g of a solid. On further drying in an oven, the final weight was 8.67 g, which represented a yield of 92.8%.

### Step 3: Synthesis of Mixture of 1,3,5,7-tetrakis-{3′/4′-[4″-(phenylethynyl)phenylethynyl]phenyl}adamantane (TPEPEPA) and 1,3/4-bis{1′,3′,5′-tris{3″/4″-[4′″-(phenylethynyl)phenylethynyl]phenyl}adamantyl}benzene (BTPEPEPAB).

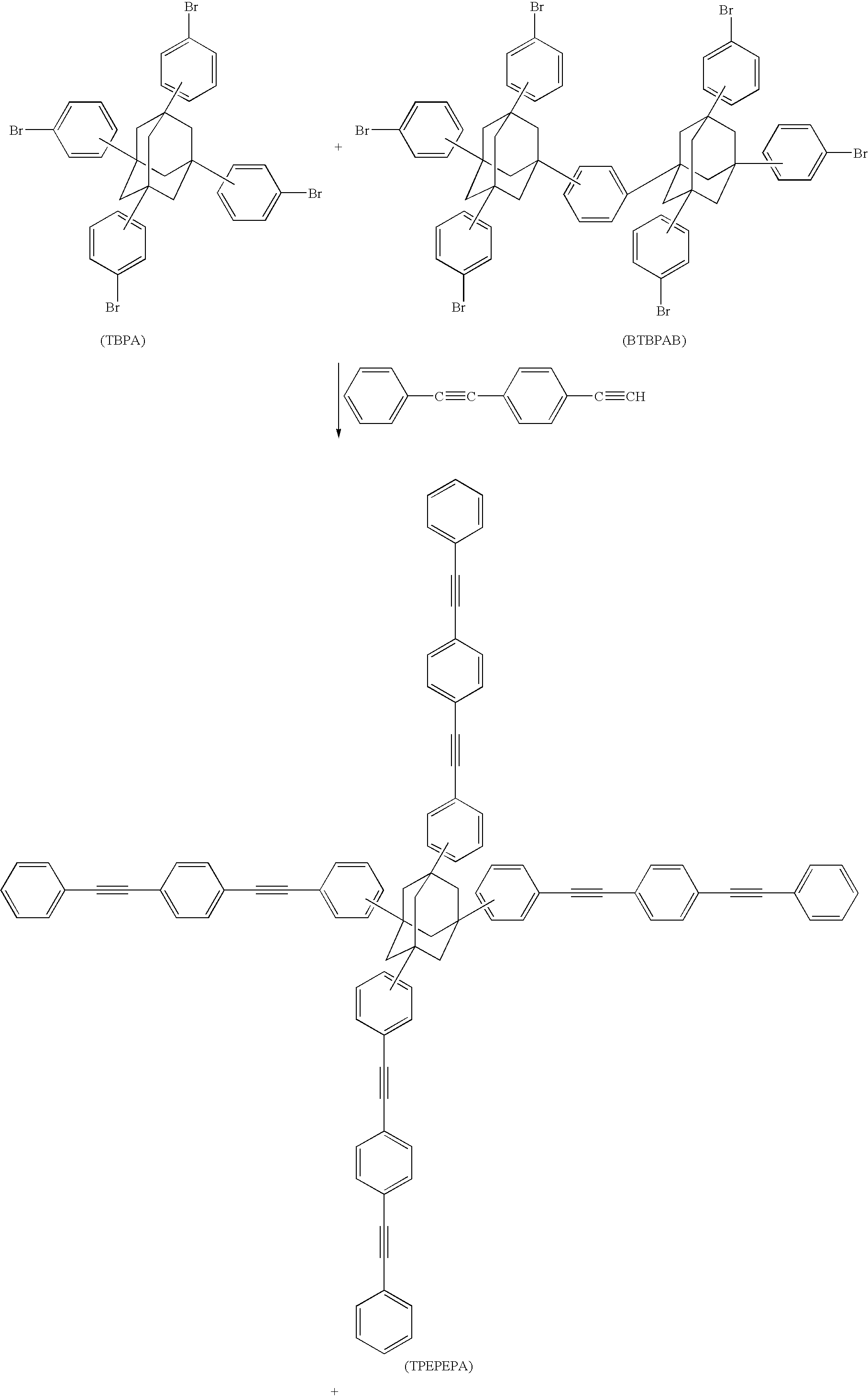

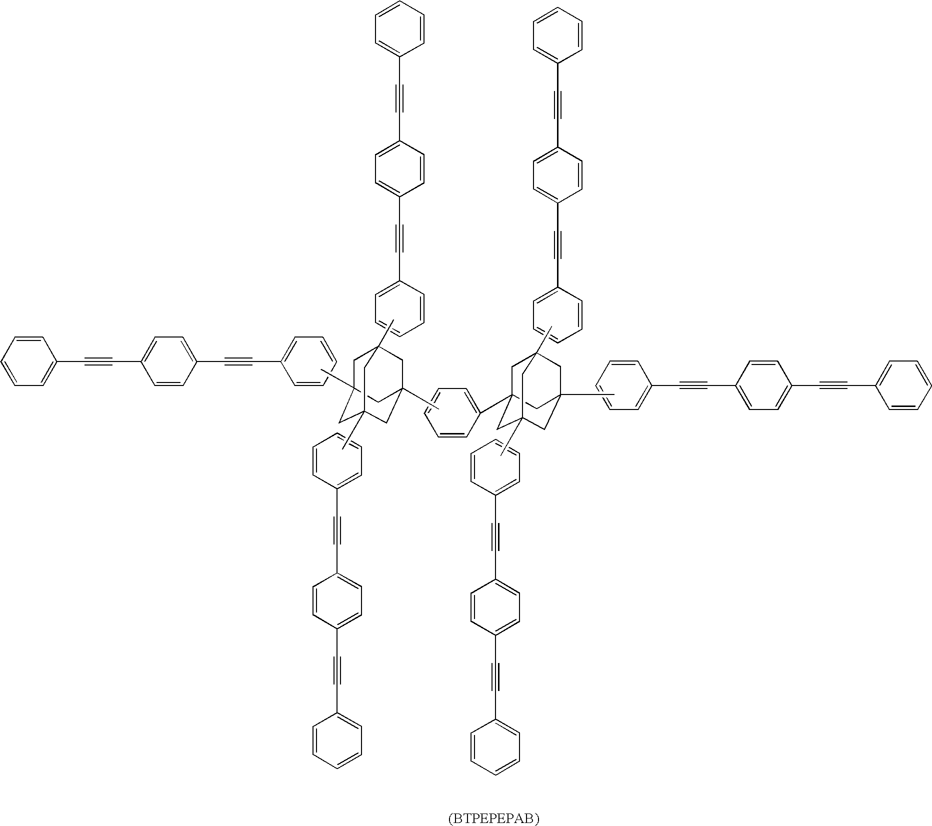

A mixture of TBPA and BTBPAB (supra) was reacted with 4-ethynyltolane to yield the final product of a mixture of 1,3,5,7-tetrakis-{3′/4′-[4″-(phenylethynyl)phenylethynyl]phenyl}adamantane (TPEPEPA) and 1,3/4-bis{1′,3′,5′-tris{3″/4″-[4′″-(phenylethynyl)phenylethynyl]phenyl}adamantyl}benzene (BTPEPEPAB) following a general protocol for a palladium-catalyzed Heck ethynylation reaction.

### EXAMPLE 7

Thermosetting component (a) (200 grams) made from a procedure similar to that of Example 5 above was loaded into a flask. Cyclohexanone, in an amount of 5.4 times the amount of thermosetting component (a), was added to the flask and the flask was shaken. The adhesion promoter (b) used was polycarbosilane (CH₂SiH₂)_{q} where q is 20-30, in an amount of 0.268 times the amount of thermosetting component (a), and was added to the flask and shaken. The final solution comprised 15 weight percent thermosetting component (a) and 6.7 weight percent polycarbosilane adhesion promoter (b) based on thermosetting compound (a).

For refluxing, a dry one-liter 3-neck round bottom flask with a magnetic stir-bar, water condenser with N₂ inlet-outlet, oil bath with thermal controller and thermocouple, and thermometer with adapter were used. The solution was boiled at reflux for about 23 hours.

The reaction mixture was cooled to 120° C. A Dean-Stark trap was installed and filled with toluene. Toluene, in an amount of 0.15 times the thermosetting component (a) amount in ml, was added to the refluxed solution. Intensive boiling and azeotroping began at 130° C. and continued for about 40 minutes until water evolution ceased. The reaction mixture temperature had increased to 148° C. Toluene and water were drained from the trap and azeotroping was continued until an additional 0.165 times the thermosetting component (a) amount of toluene and cyclohexanone were distilled. The flask temperature reached 153-155° C.

The reaction mixture was cooled to room temperature. Cyclohexanone was added so that the solution had 15 weight percent of the present composition comprising thermosetting component (a) and polycarbosilane component adhesion promoter (b). GPC showed that an oligomer formed.

The following example is directed to forming a layer of the present composition and a layer of a prior art composition.

### EXAMPLE 8

comparative A is a polyarylene ether taught by Honeywell U.S. Pat. No. 5,986,045. For Example 8, the composition of Example 7 was applied to a using the coating conditions in Table II:

TABLE II

| STEP | PROCESS | SPIN (RPM) | TIME (SECONDS) |
|---|---|---|---|
| 1 | Dispense | 0 | 2.8 |
| 2 | Delay | 0 | 1.7 |
| 3 | Spread | 1000 | 2 |
| 4 | Spin | 2000 | 40 |
| 5 | BSR | 1500 | 6 |
| 6 | EBR | 400 | 12 |
| 7 | EBR | 800 | 7 |
| 8 | Dry | 1000 | 7 |
| 9 | Dry | 1500 | 5 |
| 10 | End | 0 | 0.06 |

In Table II, BSR stands for back side rinse and EBR stands for edge bead rinse. The coater used was DNS SC-W80A-A VFDLP, pressuring gas was helium, the dispense pressure was 0.08 MPa, the dispense rate was 1.0 millimeter/second, and the inline filter was 0.1 micron PFFVO1D8S (Millipore, Fuluoroline-S).

The resulting spun-on composition was baked for one minute under N₂ (<50 ppm O₂) at each of the following temperatures: 150° C., 200° C., and 250° C. The furnace cure condition was 400° C. for 60 minutes in N₂ (15 liters/minute) with ramping up from 250° C. at 5° K per minute. The cure temperature range was from 350° C. to 450° C. Alternatively, a hot plate cure condition at 350° C. to 450° C. for 1-5 minutes in N₂ may be used.

The resulting layers were analyzed according to the analytical test methods set forth above. The layer properties are reported in Table III.

TABLE III

| PROPERTY | Comparative A | Example 8 |
|---|---|---|
| Electrical: | | |
| Dielectric constant @ 1 MHx | 2.85 | 2.65 |
| Breakdown voltage (MV/cm) | >2 | >2 |
| Thermal: | | |
| Shrinkage (%) after 400° C./10 hours | 1.2 | 1.0 |
| Shrinkage (%) after 425° C./10 hours | 4.0 | 2.0 |
| ITGA weight loss | 1.2 | 0.5 |
| After 425° C./0-30 min | | |
| ITGA weight loss | 1.6 | 0.8 |
| After 425° C./30-150 minutes | | |
| Mechanical: | | |
| T_{g} (° C.) first cycle | 400 | >430 |
| T_{g} (° C.) second cycle | 400 | >450 |
| Modulus (Gpa) | 5.0 | 6.5 |
| Hardness (Gpa) | 0.4 | 0.8 |
| Stud Pull Strength (kpsi) | >11 | >10 |
| Tape Test | Pass | Pass |
| Refractive Index @ 633 nm | 1.675 | 1.627 |
| Compatible with Solvents | Yes | Yes |

Visual inspection confirmed that no striations were present. The Tg improvement is significant for use in a harsh high temperature processing environment and the modulus improvement contributes to product integrity.

### EXAMPLES 9-11

Comparative B was 100% thermosetting compound (a) and thus, did not contain adhesion promoter (b). For Examples 9-11, Example 8 was followed to produce the compositions of Table IV except that the amount of polycarbosilane adhesion promoter (b) was varied. The polycarbosilane component (b) used was (CH₂SiH₂)_{q} where q is 20 to 30.

TABLE IV

| | Comparative | Example | Example | Example |
|---|---|---|---|---|
| | B | 9 | 10 | 11 |
| Component (b) | 0 | 3 | 6.7 | 10 |
| (weight percentage) | | | | |
| Refractive Index: | | | | |
| After Bake | 1.702 | 1.693 | 1.628 | 1.676 |
| After Cure | 1.629 | 1.619 | 1.614 | 1.615 |
| After 425° C./10 hour | Not | 1.612 | 1.607 | 1.606 |
| anneal | determined | | | |
| Thickness: | | | | |
| (Angstroms) | | | | |
| After Bake | 8449 | 8134 | 8629 | 8452 |
| After Cure | 9052 | 8711 | 9147 | 8898 |
| After 425° C./10 hour | Not | 8608 | 9019 | 8775 |
| annneal | determined | | | |
| Thickness | | | | |
| Change (%): | | | | |
| Bake-to-Cure | 7.1 | 7.0 | 6.0 | 5.3 |
| Cure-to-Anneal | Not | −1.2 | −1.4 | −1.4 |
| | determined | | | |
| Adhesion: | | | | |
| Tape Test, | Pass | Pass | Pass | Pass |
| As-prep | | | | |
| Tape Test, after | Fail | Pass | Pass | Pass |
| boiling water | | | | |
| Stud Pull Strength, | 0 | 9.4 | 9.1 | 6.1 |
| kpsi | | | | |

Thus, specific embodiments and applications of compositions and methods to produce a low dielectric constant polymer have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A composition comprising:
(a) thermosetting component wherein the thermosetting component comprises monomer having the structure 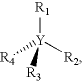
dimer having the structure 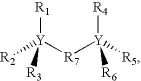
or a mixture of said monomer and said dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of said R₁, R₂, R₃, R₄, R₅, and R₆ comprises at least two isomers; and
(b) adhesion promoter comprising compound having at least bifunctionality wherein the bifunctionality may be the same or different and the first functionality is capable of interacting with said thermosetting component (a) and the second functionality is capable of interacting with a substrate when said composition is applied to said substrate.

2. The composition of claim 1 wherein said aryl comprises a moiety selected from the group consisting of (phenylethynyl)phenyl, phenylethynyl (phenylethynyl)phenyl, and (phenylethynyl)phenylphenyl.

3. The composition of claim 1 wherein said Y is selected from the group consisting of adamantane or diamantane.

4. The composition of claim 1 wherein said monomer is present.

5. The composition of claim 4 wherein said monomer is 1,3,5,7-tetrakis[3′/4′-(phenylethynyl)phenyl]adamantane.

6. The composition of claim 1 wherein said dimer is present.

7. The composition of claim 6 wherein said dimer is 1,3/4-bis(1′,3′,5′-tris[3″/4″-(phenylethynyl)phenyl]adamantyl}benzene.

8. The composition of claim 1 wherein said mixture of said monomer and said dimer is present.

9. The composition of claim 8 wherein said monomer is 1,3,5,7-tetrakis[3′/4′-(phenylethynyl)phenyl]adamantane and said dimer is 1,3/4-bis{1′,3′,5′-tris[3″/4″-(phenylethynyl)phenyl]adamantyl)benzene.

10. The composition of claim 1 wherein said at least two isomers are meta- and para-isomers.

11. The composition of claim 1 wherein said adhesion promoter (b) is selected from the group consisting of:
(i) polycarbosilane of the formula (I): 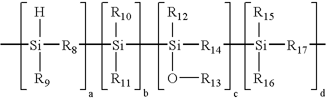
in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and,d satisfy the conditions of [4≦a+b+c+d ≦100,000], and b and c and d may collectively or independently be zero;
(ii) silanes of the formula (R₁₈)ₜ(R₁₉)_{f}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂C₆H₂(OH)(R₂₃)]ⱼ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers or polymers where the cyclic group is vinyl, aromatic, or heteroaromatic.

12. The composition of claim 11 wherein said adhesion promoter (b) is said polycarbosilane.

13. An oligomer comprising said composition of claim 1.

14. A spin-on composition comprising said oligomer of claim 13 and solvent.

15. The spin-on composition of claim 14 wherein said solvent is cyclohexanone.

16. A polymer made from said oligomer of claim 13.

17. A layer comprising said polymer of claim 16.

18. The layer of claim 17 wherein said layer has a dielectric constant of less than 3.0.

19. A substrate having thereon at least one of said layer of claim 17.

20. A substrate having thereon at least two of said layers of claim 17.

21. An electrical device comprising said substrate of claim 19.

22. A method of improving adhesion to a substrate comprising the step of:
applying to said substrate, a layer of composition comprising:
(a) thermosetting component wherein the thermosetting component comprises monomer having the structure 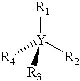
dimer having the structure 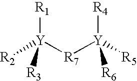
or a mixture of said monomer and dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of said R₁, R₂, R₃, R₄, R₅, and R₆ comprises at least two isomers; and
(b) adhesion promoter comprising compound having at least bifunctionality wherein the bifunctionality may be the same or different and the first functionality is capable of interacting with said thermosetting component (a) and the second functionality is capable of interacting with said substrate.

23. The method of claim 22 wherein said aryl comprises a moiety selected from the group consisting of (phenylethynyl)phenyl, phenylethynyl(phenylethynyl)phenyl, and (phenylethynyl)phenylphenyl.

24. The method of claim 22 wherein said Y is selected from the group consisting of adamantane or diamantane.

25. The method of claim 22 wherein said monomer is present.

26. The method of claim 25 wherein said monomer is 1,3,5,7-tetrakis[3′/4′-(phenylethynyl)phenyl]adamantane.

27. The method of claim 22 wherein said dimer is present.

28. The method of claim 27 wherein said dimer is 1,3/4-bis{1′,3′,5′-tris[3″/4″-(phenylethynyl)phenyl]adamantyl}benzene.

29. The method of claim 22 wherein said mixture of said monomer and said dimer is present.

30. The method of claim 29 wherein said monomer is 1,3,5,7-tetrakis[3′/4′-(phenylethynyl)phenyl]adamantane and said dimer is 1,3/4-bis{1′,3′,5′-tris[3″/4″-(phenylethynyl)phenyl]adamantyl}benzene.

31. The method of claim 22 wherein said at least two isomers are meta- and para-isomers.

32. The method of claim 22 wherein said adhesion promoter (b) is selected from the group consisting of:
(i) polycarbosilane of the formula (I) 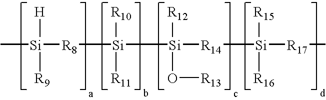
in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkylene, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;
(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂C₆H₂(OH)(R₂₃)]ⱼ— where R₂₂ is substituted or unsubstituted alkylene, cycloalkylene, vinyl, allyl, or aryl; R₂₂is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers or polymers wherein said cyclic group is pyridine, aromatic, or heteroaromatic.

33. The method of claim 32 wherein said adhesion promoter (b) is said polycarbosilane.

34. A composition comprising:
(a) thermosetting monomer having the structure 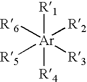
wherein Ar is aryl, and R′₁, R′₂, R′₃, R′₄, R′₅, and R′₆ are independently selected from aryl, branched aryl, arylene ether, and no substitution; and each of the aryl, the branched aryl, and the arylene ether has at least one ethynyl group; and
(b) adhesion promoter comprising compound having at least bifunctionality wherein the bifunctionality may be the same or different and the first functionality is capable of interacting with said thermosetting monomer (a) and the second functionality is capable of interacting with a substrate when said composition is applied to said substrate.

35. The composition of claim 34 wherein said adhesion promoter (b) is selected from the group consisting of:
(i) polycarbosilane of the formula (I): 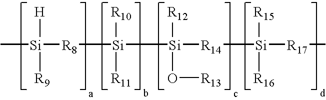
in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;
(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂C₈H₂(OH)(R₂₃)]ⱼ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers where said cyclic group is pyridine, aromatic, or heteroaromatic.

36. The composition of claim 35 wherein said adhesion promoter (b) comprises said polycarbosilane.

37. A spin-on composition comprising said composition of claim 34 and solvent.

38. The spin-on composition of claim 37 wherein said solvent is cyclohexanone.

39. A layer comprising said spin-on composition of claim 37.

40. A method of producing low dielectric constant polymer precursor comprising the steps of:
(1) providing composition comprising:
(a) thermosetting component wherein said thermosetting component comprises monomer having the structure 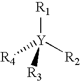
dimer having the structure 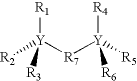
or a mixture of said monomer and said dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of said R₁, R₂, R₃, R₄, R₅, and R₆ comprises at least two isomers; and
(b) adhesion promoter comprising compound having at least bifunctionality wherein the bifunctionality may be the same or different and the first functionality is capable of interacting with said thermosetting component (a) and the second functionality is capable of interacting with a substrate when said composition is applied to said substrate; and
(2) treating said composition at a temperature from about 30° C. to about 350° C. for about 0.5 to about 60 hours thereby forming said low dielectric constant polymer precursor.

41. The method of claim 40 wherein said monomer is present.

42. The method of claim 41 wherein said monomer is 1,3,5,7-tetrakis[3′/4′-(phenylethynyl)phenyl]adamantane.

43. The method of claim 40 wherein said dimer is present.

44. The method of claim 43 wherein said dimer is 1,3/4-bis{1′,3′,5′-tris[3″/4″-(phenylethynyl)phenyl]adamantyl}benzene.

45. The method of claim 40 wherein said mixture of said monomer and said dimer is present.

46. The method of claim 45 wherein said monomer is 1,3,5,7-tetrakis[3′/4′-(phenylethynyl)phenyl]adamantane and said dimer is 1,3/4-bis{1′,3′,5′-tris[3″/4″-(phenylethynyl)phenyl]adamantyl}benzene.

47. The method of claim 40 wherein said adhesion promoter (b) is selected from the group consisting of:
(i) polycarbosilane of the formula (I): 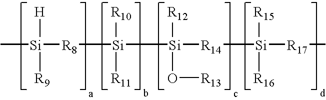
in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;
(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂C₆H₂(OH)(R₂₃)ⱼ— where R₂₂ is substituted or unsubstituted alkylene, cycloalkylene, vinyl, allyl, or arylene; R₂₃ is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers or polymers where said cyclic group is pyridine, aromatic, or heteroaromatic.

48. A method of producing low dielectric constant polymer, comprising the steps of:
(1) providing oligomer of (a) thermosetting component wherein said thermosetting component comprises monomer having the structure 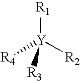
dimer having the structure 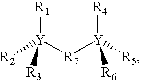
or a mixture of said monomer and said dimer wherein Y is selected from cage compound and silicon atom; R₁, R₂, R₃, R₄, R₅, and R₆ are independently selected from aryl, branched aryl, and arylene ether; at least one of the aryl, the branched aryl, and the arylene ether has an ethynyl group; R₇ is aryl or substituted aryl; and at least one of said R₁, R₂, R₃, R₄, R₅, and R₆ comprises at least two isomers; and (b) adhesion promoter comprising compound having at least bifunctionality wherein the bifunctionality may be the same or different and the first functionality is capable of interacting with said thermosetting component (a) and the second functionality is capable of interacting with a substrate when said composition is applied to said substrate; and
(2) polymerizing said oligomer thereby forming said low dielectric constant polymer, wherein the polymerization comprises a chemical reaction of said ethynyl group.

49. The method of claim 48 wherein said Y is selected from the group consisting of adamantane and diamantane.

50. The method of claim 48 wherein said aryl comprises a moiety selected from the group consisting of (phenylethynyl)phenyl, phenylethynyl(phenylethynyl)phenyl, and (phenylethynyl)phenylphenyl.

51. The method of claim 48 wherein at least three of the aryl, the branched aryl, and the arylene ether have a ethynyl group, and wherein the polymerization comprises a chemical reaction of at least two of said ethynyl groups.

52. The method of claim 48 wherein all of the aryl, the branched aryl, and the arylene ether have an ethynyl group, and wherein the polymerization comprises a chemical reaction of the ethynyl groups.

53. The method of claim 48 wherein said monomer is present.

54. The method of claim 53 wherein said monomer is 1,3,5,7-tetrakis[3′/4′-(phenylethynyl)phenyl]adamantane.

55. The method of claim 48 wherein said dimer is present.

56. The method of claim 55 wherein said dimer is 1,3/4-bis{1″,3″,5′-tris[3″/4″-(phenylethynyl)phenyl]adamantyl}benzene.

57. The method of claim 48 wherein said mixture of said monomer and said dimer is present.

58. The method of claim 57 wherein said monomer is 1,3,5,7-tetrakis[3′/4′-(phenylethynyl)phenyl]adamantane and said dimer is 1,3/4-bis{1′,3′,5′-tris[3″/4″-(phenylethynyl)phenyl]adamantyl}benzene.

59. The method of claim 48 wherein said at least two isomers are meta- and para-isomers.

60. The method of claim 48 wherein said thermosetting component (a) is dissolved in a solvent.

61. The method of claim 48 wherein said adhesion promoter (b) is selected from the group consisting of
(i) polycarbosilane of the formula (I): 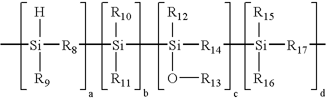
in which R₈, R₁₄ and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;
(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂ C₆H₂(OH)(R₂₃)]ⱼ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers or polymers where said cyclic group is pyridine, aromatic, or heteroaromatic.

62. Spin-on low dielectric constant material comprising:
(a) first backbone having first aromatic moiety and first reactive group and second backbone having second aromatic moiety and second reactive group wherein the first and second backbones are crosslinked via the first and second reactive groups in a crosslinking reaction and cage structure covalently bound to at least one of the first and second backbones wherein the cage structure comprises at least eight atoms; and
(b) adhesion promoter comprising compound having at least bifunctionality wherein the bifunctionality may be the same or different and the first functionality is capable of interacting with said first and second backbones and the second functionality is capable of interacting with a substrate when said material is applied to said substrate.

63. The spin-on low dielectric constant material of claim 62 wherein said aromatic moiety comprises a phenyl.

64. The spin-on low dielectric constant material of claim 62 wherein at least one of the first reactive group or the second reactive group comprises an ethynyl group.

65. The spin-on low dielectric constant material of claim 62 wherein the cage structure comprises at (east one of adamantane and diamantane.

66. The spin-on low dielectric constant material of claim 62 wherein the cage structure comprises a substituent.

67. The spin-on low dielectric constant material of claim 62 wherein said adhesion promoter (b) is selected from the group consisting of:
(i) polycarbosilane of the formula (I): 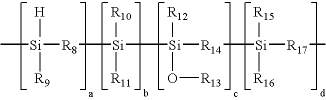
in which R₈, R₁₄, and R₁₇ each independently represents substituted or unsubstituted alkylene, cycloalkylene, vinylene, allylene, or arylene; R₉, R₁₀, R₁₁, R₁₂, R₁₅, and R₁₆ each independently represents hydrogen atom, alkyl, alkylene, vinyl, cycloalkyl, allyl, aryl, or arylene and may be linear or branched; R₁₃ represents organosilicon, silanyl, siloxyl, or organo group; and a, b, c, and d satisfy the conditions of [4≦a+b+c+d≦100,000], and b and c and d may collectively or independently be zero;
(ii) silanes of the formula (R₁₈)_{f}(R₁₉)_{g}Si(R₂₀)ₕ(R₂₁)ᵢ wherein R₁₈, R₁₉, R₂₀, and R₂₁ each independently represents hydrogen, hydroxyl, unsaturated or saturated alkyl, substituted or unsubstituted alkyl where the substituent is amino or epoxy, unsaturated or saturated alkoxyl, unsaturated or saturated carboxylic acid radical, or aryl; at least two of said R₁₈, R₁₉, R₂₀, and R₂₁ represent hydrogen, hydroxyl, saturated or unsaturated alkoxyl, unsaturated alkyl, or unsaturated carboxylic acid radical; and f+g+h+i≦4;
(iii) phenol-formaldehyde resins or oligomers of the formula —[R₂₂C₆H₂(OH)(R₂₃)]ⱼ— where R₂₂ is substituted or unsubstituted alkylene, cycloalkylene, vinyl, allyl, or aryl; R₂₃ is alkyl, alkylene, vinylene, cycloalkylene, allylene, or aryl; and j=3-100;
(iv) glycidyl ethers;
(v) esters of unsaturated carboxylic acids containing at least one carboxylic acid group; and
(vi) vinyl cyclic oligomers or polymers where the cyclic group is pyridine, aromatic, or heteroaromatic.

68. A spin-on low dielectric constant polymer comprising:
(a) polymer having pendant cage structures —[OR₂₄(R₂₅)ₘOR₂₆]ₙ— wherein R₂₄ is —C₆H₃—; R₂₅ is adamantane, diamantane, (C₆H₅)ₚ(adamantane), or (C₆H₅)ₚ(diamantane); m=1-3; n=1-10³; p=0 or 1; and R₂₆ is a radical of 2,3,4,5-(tetraphenyl)cyclodienone-1 or 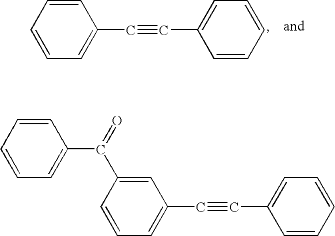
(b) adhesion promoter comprising compound having at least bifunctionality wherein the bifunctionality may be the same or different and the first functionality is capable of interacting with said polymer and the second functionality is capable of interacting with a substrate when said polymer is applied to said substrate.
